(19) United States
(12) Patent Application Publication
(10) Pub. No.: US 2018/0206210 A1
(43) Pub. Date: Jul. 19, 2018

(54) COMMUNICATION DEVICE, COMMUNICATION PROCESSING METHOD, AND PROGRAM

(71) Applicant: SHARP KABUSHIKI KAISHA, Sakai City, Osaka (JP)

(72) Inventors: SHUMPEI FUSE, Sakai City (JP); SHUICHI TAKEHANA, Sakai City (JP); TOSHIAKI KAMENO, Sakai City (JP); YUHSUKE TAKAGI, Sakai City (JP); HIDEYUKI NAKANISHI, Sakai City (JP)

(21) Appl. No.: 15/743,415

(22) PCT Filed: Jun. 10, 2016
(86) PCT No.: PCT/JP2016/067354

§ 371 Date: Jan. 10, 2018

(30) Foreign Application Priority Data
Aug. 31, 2015 (JP) 2015-170577

(51) Int. Cl. H04W 72/02; H04W 92/18; H04W 72/10; H04W 4/08

(52) U.S. Cl. CPC H04W 72/02; H04W 92/18; H04W 76/14; H04W 4/08; H04W 72/10

(57) ABSTRACT

A UE performs communication with another UE. A UE detects another communication different from the communication. The UE has a predetermined communication resource selection rule stored therein. The UE controls the communication. When the other communication is detected, the UE selects a communication resource based on the stored communication resource selection rule. This allows radio waves to be utilized efficiently.

### TECHNICAL FIELD

The present invention relates to a communication device capable of wireless communication, a communication processing method in the communication device, and a program for controlling the communication device.

### BACKGROUND ART

Conventionally, there is known device-to-device (D2D) communication in which terminals (UE: User Equipment) communicate directly with each other without traversing a base station (eNB: evolved Node B). Device-to-device communication is also referred to as D2D Proximity Services (ProSe). Proximity Services is standardized in Release 12 of 3rd Generation Partnership Project (3GPP). In such device-to-device communication, each terminal needs to support off-network communication, Mission Critical Push-To-Talk (MCPTT) including group call communication.

Note that off-network communication and Mission Critical Push-To-Talk (MCPTT) continue as part of Release 13 of 3GPP, Furthermore, Group Call System Enablers (GCSE) has been standardized in Release 12.

Japanese Patent Laying-Open No, 2013-187554 (Patent Document 1) discloses “Wireless communication system that accurately provides emergency information to a user existing in a specific area.” Specifically, Patent Document 1 describes that a first communication device transmits emergency information at a first frequency to a wireless terminal located within an area P. A second communication device communicates first information different from the emergency information with the wireless terminal located in area P at a second frequency different from the first frequency (see the Abstract).

### CITATION LIST

### Patent Document

Patent document 1: Japanese Patent Laying-Open No. 2013-187554

### SUMMARY OF INVENTION

### Technical Problem

However, according to the technique of Patent Document 1, even when the second frequency different than the emergency information is congested and the first frequency for transmitting the emergency information is available, the first information different from the emergency information cannot be transmitted using the first frequency. Therefore, the technique of Patent Document 1 utilizes radio waves inefficiently.

The present invention has been made in view of the above problem, and it is an object thereof to provide a communication device allowing radio waves to be utilized efficiently, a communication processing method in the communication device, and a program for controlling the communication device.

### Solution to Problem

According to an aspect of the present invention, a communication device comprises a communication unit configured to perform communication with another communication device, a detection unit configured to detect another communication different from the communication, a storage unit configured to store a predetermined communication resource selection rule, and a processing unit configured to control communication. When the detection unit detects the other communication, the processing unit selects a communication resource based on the communication resource selection rule stored in the storage unit.

### ADVANTAGEOUS EFFECTS OF INVENTION

The present invention allows radio waves to be utilized efficiently.

### BRIEF DESCRIPTION OF DRAWINGS

FIG. 1 is a diagram for illustrating a schematic configuration of a communication system according to an embodiment.

FIG. 2 is a block diagram for illustrating a functional configuration of a UE.

FIG. 3 is a flowchart for illustrating an example of a flow of a processing in a UE.

FIG. 4 is a flowchart for illustrating another example of a flow of a processing in a UE.

FIG. 5 is a sequence diagram for illustrating a flow of a processing in a communication system in an aspect.

FIG. 6 is a conceptual diagram of a priority table D6 defining priorities.

FIG. 7 is a conceptual diagram of a frequency table D7 defining frequency bands.

FIG. 8 is a flowchart for illustrating a flow of a processing of a UE.

FIG. 9 is a flowchart for illustrating a flow of a processing of a UE.

FIG. 10 is a sequence diagram for illustrating a flow of a processing in the communication system in an aspect.

FIG. 11 is a block diagram for illustrating a functional configuration of a UE according to another embodiment.

FIG. 12 is a flowchart for illustrating an example of a flow of a processing in a UE.

FIG. 13 is a flowchart for illustrating another example of a flow of a processing in a UE.

FIG. 14 is a sequence diagram for illustrating a flow of a processing in the communication system in an aspect.

FIG. 15 is a conceptual diagram of a time slot table defining a time slot usable for a group call.

FIG. 16 is a flowchart for illustrating a flow of a processing of a UE.

FIG. 17 is a flowchart for illustrating a flow of a processing of a UE.

FIG. 18 is a sequence diagram for illustrating a flow of a processing in the communication system in an aspect.

FIG. 19 is a block diagram for illustrating a functional configuration of a UE according to still another embodiment.

FIG. 20 is a flowchart for illustrating an example of a flow of a processing in a UE.

FIG. 21 is a flowchart for illustrating another example of a flow of a processing in a UE.

FIG. 22 is a sequence diagram for illustrating a flow of a processing in the communication system in an aspect.

FIG. 23 is a conceptual diagram of a resource block table defining a resource block usable for a group call.

FIG. 24 is a flowchart for illustrating a flow of a processing of a UE.

FIG. 25 is a flowchart for illustrating a flow of a processing of a UE.

FIG. 26 is a sequence diagram for illustrating a flow of a processing in the communication system in an aspect.

FIG. 27 is a block diagram for illustrating a functional configuration of a UE according to still another embodiment.

FIG. 28 is a flowchart for illustrating an example of a flow of a processing in a

FIG. 29 is a flowchart fir illustrating another example of a flow of a processing in a UE.

FIG. 30 is a sequence diagram for illustrating a flow of a processing in the communication system in an aspect.

FIG. 31 is a flowchart for illustrating a flow of a processing of a UE.

FIG. 32 is a flowchart for illustrating a flow of a processing of a UE.

FIG. 33 is a sequence diagram for illustrating a flow of a processing in the communication system in an aspect.

### DESCRIPTION OF EMBODIMENTS

Hereinafter, a communication system according to each embodiment of the present invention will be described with reference to the drawings. In particular, a mobile terminal (hereinafter referred to as a “UE”) constituting the communication system will be described below. The UE may include a variety of communication devices such as a smartphone, a tablet, terminal, a Fabret terminal and the like. However, the UE is not limited to these devices.

Although details will be described later, selection of a communication resource (a radio resource) by a UE will be described in the following embodiments. Specifically in the following description will be described a configuration in which a UE selects a frequency band (see first and fourth embodiments), a configuration in which a UE selects a time slot (see second and fourth embodiments), and a configuration in which a UE selects a resource block (see third and fourth embodiments).

In the following description, identical components are identically denoted. Their names and functions are also identical. Accordingly, they will not be described repeatedly.

### First Embodiment

### 1. System Configuration

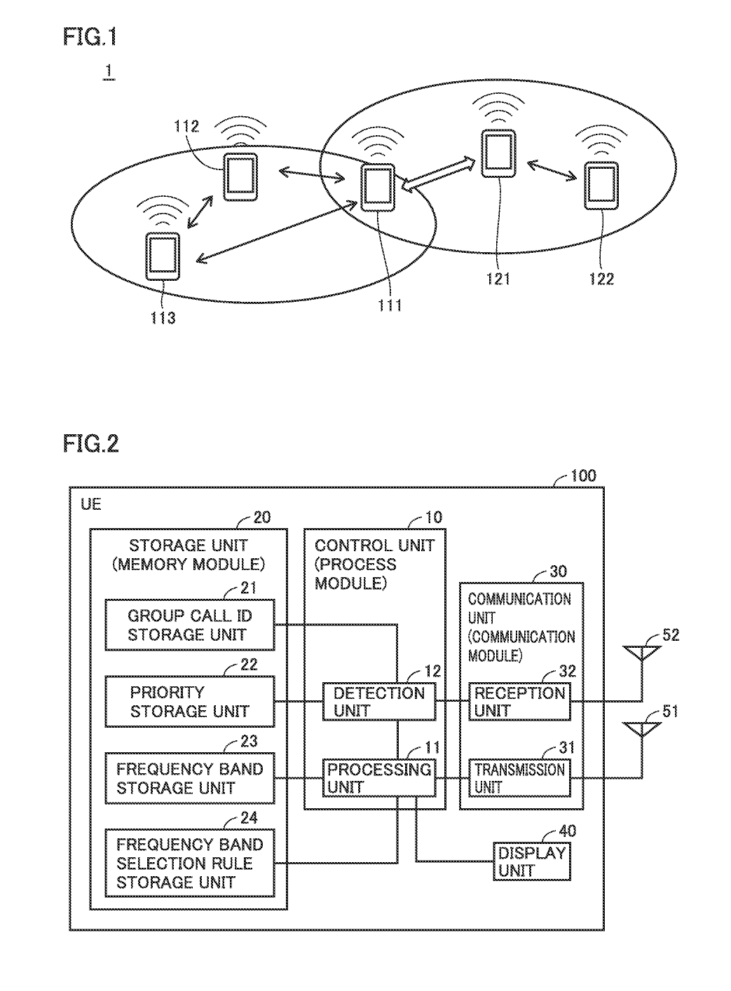

FIG. 1 is a diagram for illustrating a schematic configuration of a communication system 1 according to the present embodiment. With reference to FIG. 1, communication system 1 are configured including a plurality of UEs 111, 112, 113, 121, 122. The UE supports device-to-device communication, off-network communication, Mission Critical Push-To-Talk (MCPTT) including group call communication, and the like.

In the example of FIG. 1, UE 111, UE 112, and UE 113 form a first group. UEs 111, 112, and 113 can each perform group communication with a counterpart UE within the first group without going through a base station (not shown). Furthermore, UP 121 and UE 122 form a second group. UEs 121 and 122 can each perform group communication with a counterpart UE within the second group without going through a base station. Further, in the example of FIG. 1, UE 111 and UE 121, which belong to different groups, respectively, communicate with each other. This communication will more specifically be described later.

Hereinafter, a description will be given of a case where a group call is made by device-to-device communication without going through a base station specifically, direct communication in an off-network). Note that it is assumed that the group call is made selectively using at least one of a plurality of frequency bands (more specifically, band classes). In the following description, when UEs 111, 112, 113, 121, and 122 are not distinguished, they are referred to as a “UE 100”.

### 2. Functional Configuration

FIG. 2 is a block diagram for illustrating a functional configuration of UE 100. With reference to FIG. 2, UE 100 comprises a control unit 10, a storage unit 20, a communication unit 30, a display unit 40, a transmitting antenna 51, and a receiving antenna 52. Control unit 10 includes a processing unit 11 and detection unit 12. Storage unit 20 includes a group call ID storage unit 21, a priority storage unit 22, a frequency band storage unit 23, and a frequency band selection rule storage unit 24. Communication unit 30 includes a transmission unit 31 and a reception unit 32.

Typically, control unit 10 is configured as a process module, Typically, storage unit 20 is configured as a memory module. Typically, communication unit 30 is configured as a communication module.

Control unit 10 is communicably connected to storage unit 20 and communication unit 30 by a bus or the like. Control unit 10 generally controls the operation of UE 100.

Storage unit 20 has an operating system, a variety of application programs, and a variety of data stored therein

Group call ID storage unit 21 has stored therein a group call ID of a group to which a terminal provided with the unit (hereinafter also referred to as an “own terminal”) belongs. Typically, the group call ID is stored in group call ID storage unit 21 based on an operation done by the user of UE 100. One UE 100 may have a plurality of group call IDs so that the UE can participate in a plurality of group calls.

Priority storage unit 22 has stored therein a priority of each group call ID. The priority is set based for example on an operation done by the user. Further, communication system 1 may be configured so that an operator or a service provider or the like sets the priority. The priority will more specifically be described later FIG. 5).

Frequency band storage unit 23 has stored therein a frequency band (a subband) usable for device-to-device communication.

Frequency band selection rule storage unit 24 has stored therein a rule applied in determining a frequency band to be used or not to be used according to the priority. More specifically, frequency band selection rule storage unit 24 has stored therein a rule (hereinafter also referred to as a predefined rule) applied in determining a frequency band to be used or not to be used according to the priority when it is detected during a group call that another group (e.g., the second group) is making a group call within a range determined to affect a group call of the group of the its own terminal (e.g., the first group). A specific example of the rule will be described later.

Reception unit 32 receives a group call ID and a priority from another UE 100 via a receiving antenna 52. The received group call ID and priority are transmitted to detection unit 12.

Detection unit 12 detects another communication (a group call of another group) different from communication (a group call) of a group provided with the unit (hereinafter also referred to as an “own group”). Specifically, detection unit 12 compares a group call ID and priority received from another UE 100 with a group call ID and priority of the its own terminal stored in storage unit 20. Detection unit 12 notifies processing unit 11 of a result of comparing the priorities.

Processing unit 11 controls communications with another UE 100. Further, when detection unit 12 detects another communication, processing unit 11 selects a frequency band (a communication resource) based on a frequency band selection rule (a communication resource selection rule) stored in storage unit 20. Further, processing unit 11 notifies the other UE 100 of information of the selected frequency band (or communication resource) via communication unit 30.

More specifically, during a group call when another group's call is detected, processing unit 11 determines a frequency to be used for the group call based on the above predefined rule and a result of comparing the priority of the group call of the its own terminal and that of the other group's call. Specifically, processing unit 11 determines the frequency band to be used for the group call by applying the comparison result to the predefined rule. The frequency band is specifically determined in a method which will be described later.

Furthermore, processing unit 11 announces the group call ID and priority of its own terminal stored in storage unit 20 to another UE 100 via transmission unit 31 and transmitting antenna 51. Specifically, processing unit 11 announces the group call ID and priority of its own terminal to the other UE 100 by using a D2D discovery signal during a group call.

Display unit 40 displays a variety of information based on an instructions issued from control unit 10.

### 3. Control structure

(1) First Exemplary Processing

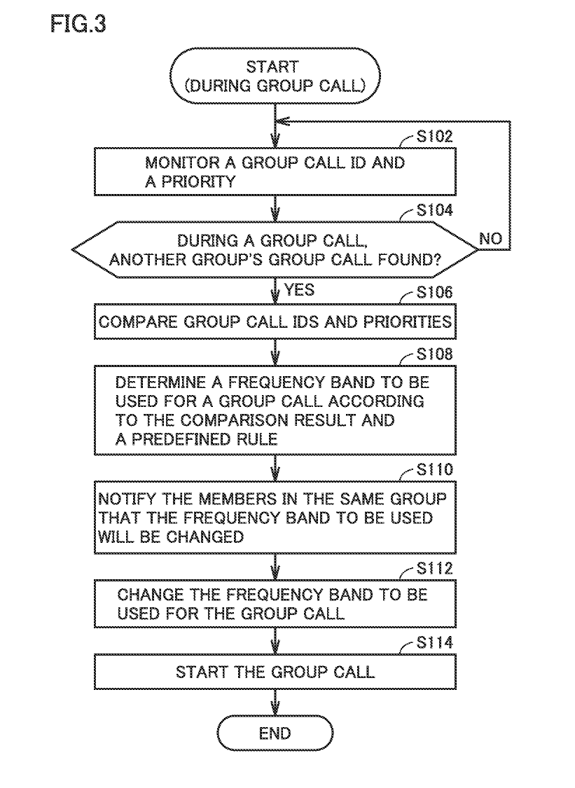

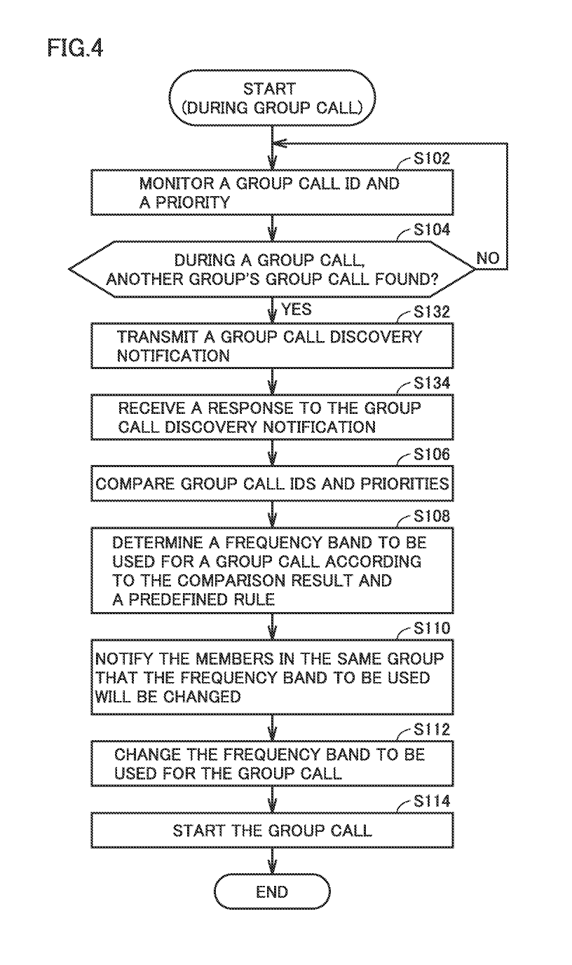

FIG. 3 is a flowchart for illustrating an example of a flow of a processing in UE 100. Referring to FIG. 3, during a group call, in step S102, UE 100 monitors a group call ID and a priority. That is, UE 100 monitors a group call ID and priority transmitted from another UE 100.

In step S104, UE 100 determines whether or not during the group call a group call of another group has been found. When it is determined that the group call has been found (YES in step S104), then, in step S106, UE 100 compares the group call ID and priority of the found group call with a group call ID and priority stored in storage unit 20 of the terminal. When it is determined that no such group call is found (NO in step S104), UE 100 proceeds with step S102.

In step S108, UE 100 determines a frequency to be used for a group call according to the comparison result and the above predefined rule. In step S110, when the determined frequency is different from the currently used frequency, UE 100 notifies the members in the same group as UE 100 (that is, the UEs 100 belonging to the same group) that the frequency to be used will be changed. In step S112, UE 100 changes sets)) the frequency to be used for the group call to the determined frequency. In step S114, UE 100 uses the changed frequency to start (or resume) the group call with UE 100 belonging to the group.

(2) Second Exemplary Processing

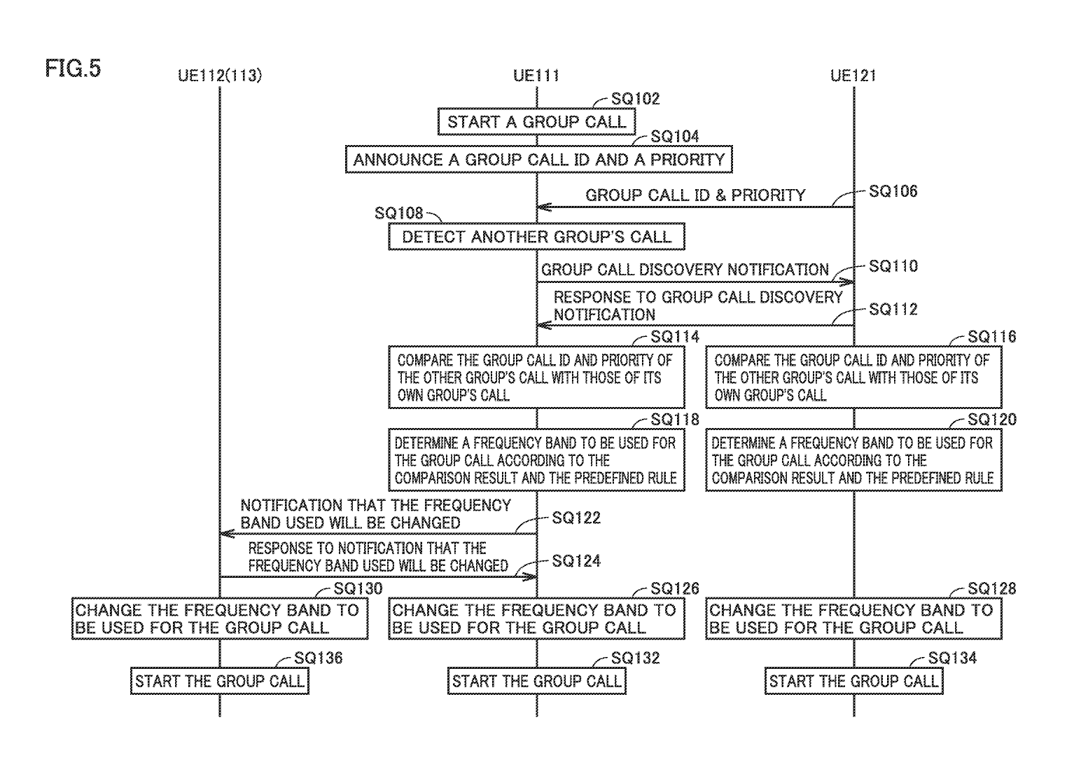

FIG. 4 is a flowchart for illustrating another example of a flow of a processing in UE 100. FIG. 4 indicates a second exemplary processing, which differs from the first exemplary processing indicated in FIG. 3 in that the former includes steps S132 and S134 between step S104 and step S106 indicated in FIG. 3. Accordingly, in the following, step S132 and step S134 will be described, and the other steps will not be described repeatedly.

In step S132, UE 100 transmits to another UE 100 notification indicating that a group call has been found (hereinafter also referred to as a “group call discovery notification”). In step S134, UE 100 receives a response notification in response to the group call discovery notification from the other UE 100 that has received the group call discovery notification. It should be noted that UE 100 may be configured so as to perform step S106 without performing step S134.

UE 100 may transmit a group call discovery notification to a UE 100 in the same group as the UE 100 that is a sender of the group call discovery notification (hereinafter also referred to as an “own group”), or UE 100 may transmit a group call discovery notification to a UE 100 of another group performing a group call found by the UE 100 that is a sender of the group call discovery notification (hereinafter also referred to as a “found other group”).

When UE 100 transmits a group call discovery notification to UE 100 of its own group, UE 100 includes the group call ID of the found other group and the priority of that other group in the group call discovery notification. The group call discovery notification may be transmitted by using a group call or by using a discovery signal.

When UE 100 transmits a group call discovery notification to UE 100 of the found other group, UE 100 includes in the group call discovery notification the group call ID of its own group and the priority of its own group ac well ac the group call ID of the found other group and the priority of the found other group. In that case, UE 100 transmits the group call discovery notification by using the discovery signal.

(3) Sequence in the Case of the Second Exemplary Processing

FIG. 5 is a sequence diagram for illustrating a flow of a processing in communication system 1 in an aspect. Specifically, FIG. 5 is a diagram for illustrating a sequence in a case where a processing based on the above-described second exemplary processing is performed in UE 111. Hereinafter, a configuration in which a group call discovery notification is transmitted to UE 100 of another group will be described.

Referring to FIG. 5, in a sequence SQ102, UE 111 belonging to the first group starts a group call with UEs 112 and 113 belonging to the first group. In a sequence SQ104, UE 111 announces the group call ID of the group of UE 111 (that is, the first group) and the priority of that group to another UE 100.

In a sequence SQ106, UE 121 of the second group announces the group call ID of the group of UE 121 (that is, the second group) and the priority of that group to another UE 100. In a sequence SQ108, UE 111 detects a group call other than the group call of its own group (hereinafter also referred to as “another group's call”).

In a sequence SQ110, UE 111 transmits a group call discovery notification to UE 121 of the second group. In a sequence SQ112, UE 121 responds to the group call discovery notification.

In a sequence SQ114, UE 111 compares the group call ID and priority of the other group's call with the group call ID and priority of its own group's call. In a sequence SQ116, UE 121 compares the group call ID and priority of the other group's call with the group call ID and priority of its own group's call.

In a sequence SQ118, UE 111 determines a frequency to be used for the group call of its own group (i.e., the first group) according to the comparison result and the predetermined rule. In a sequence SQ120, UE 121 determines a frequency to be used for the group call of its own group (i.e., the second group) according to the comparison result and the predetermined rule.

In a sequence SQ122, in order to set the frequency determined by UE 111 to be a frequency used for a subsequent group call, UE 111 notifies UEs 112 and 113 in the same group as UE 111 that the frequency used for the group call will be changed. More specifically, UE 111 transmits an instruction to UEs 112 and 113 for causing them to use the determined frequency. In a sequence SQ124, in response to the notification indicating that the frequency will be changed, UEs 112 and 113 return a response to UE 111.

In a sequence SQ126, UE 111 changes the frequency to be used for its group call to the frequency determined in sequence SQ118. In a sequence SQ128, UE 121 changes the frequency to be used for its group call to the frequency determined in sequence SQ120. In a sequence SQ130, UEs 112, 113 change the frequency to be used for their group call to the frequency that the UEs are notified of in sequence SQ122.

In a sequence SQ132, UE 111 starts (or resumes) its group call using its changed frequency. In a sequence SQ134, UE 121 starts (or resumes) its group call using its changed frequency. In a sequence SQ136, UEs 112, 113 start (or resume) their group call using their changed frequency.

### 4. Data

Hereinafter, how a frequency to be used for a group call is determined will be described with reference to a specific example. Specifically, an example of a method of determining a frequency by using a result of comparing priorities and a defined rule will be described.

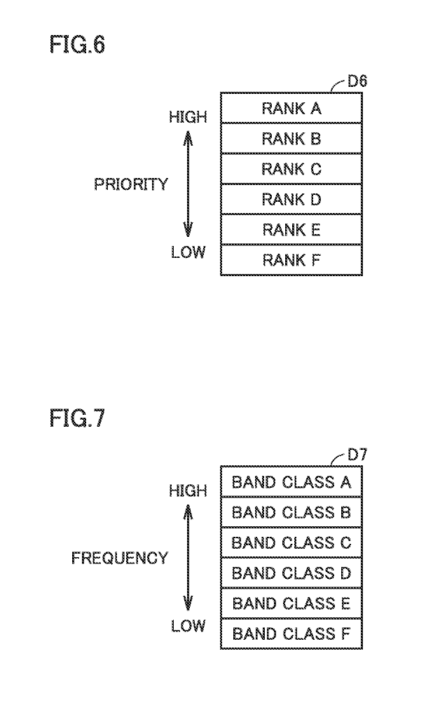

FIG. 6 is a conceptual diagram of a priority table D6 defining priorities. Referring to FIG. 6, in priority table D6, six ranks are defined as priorities. Specifically, in priority table D6 a rank A, a rank B, a rank C, a rank D, a rank E, and a rank F are defined sequentially in a descending order in priority. Note that priority table D6 is an example, and the number of ranks is not limited to the above.

FIG. 7 is a conceptual diagram of a frequency table D7 defining frequency bands. Referring to FIG. 7, in frequency table D7, six band classes are defined as frequency bands. Specifically, a band class A, a band class B, a band class C, a band class D, a band class E, and a band class F are defined sequentially in a descending order in frequency. Typically, band classes A to F have equal frequency bands. Note that frequency table D7 is an example, and the number and classification of frequency bands are not limited to the above.

Hereinafter, a method of determining a frequency (or band class) to be used will be described for different cases.

(1) When Group Calls of Different Ranks are Detected

(i) Adjustment Between Group Call of Rank A and Group Call of Rank B

For example, when UE 111 has a priority of rank A and UE 121 has a priority of rank B, and UEs 111 and 121 each receive an announcement of a priority from the other UE, a frequency to be used for a subsequent group call is determined, as follows:

UE 111 of rank A uses four band classes A to D. UE 121 of rank B having a priority lower than rank A uses two band classes E and F.

Whenever UE 100 receives an announcement of a group call ID and a priority, the above processing is performed by UE 100 that has received the announcement. It should be noted that the same applies to a case of another adjustment described below.

(ii) Adjustment Between Group Call of Rank A and Group Call of Rank E

For example, when UE 111 has a priority of rank A and UE 121 has a priority of rank E, and UEs 111 and 121 each receive an announcement of a priority from the other UE, a frequency to be used for a subsequent group call is determined, as follows:

UE 111 of rank A uses five band classes A to E. UE 121 of rank E having a priority lower than rank A uses one band class F.

As a difference in priority between rank A and rank E is larger than a difference in priority between rank A and rank B, the number of band classes used by UE 121 is reduced to be smaller in the case of rank E of a group call of UE 121 than in the case of rank B thereof.

(iii) Adjustment Between Group Call of Rank A and Group Call of Rank

For example, when UE 111 has a priority of rank A and UE 121 has a priority of rank F, and UEs 111 and 121 each receive an announcement of a priority from the other UE, a frequency to be used for a subsequent group call is determined, as follows:

UE 111 of rank A uses all of band classes A to E. UE 121 of rank F stops its group call. That is, for rank F, UE 100 does not allocate a frequency band to a group call.

As a difference in priority between rank A and rank F is larger than a difference in priority between rank A and rank E, the number of band classes used by UE 111 is increased to be larger in the case of rank F of a group call of UE 121 than in the case of rank E thereof.

(2) When Group Calls Having the Same Rank are Detected

For example, when UE 111 has a priority of rank B and UE 121 has a priority of rank B, and UEs 111 and 121 each receive an announcement of a priority from the other UE, a frequency to be used for a subsequent group call is determined, as follows:

UE 111 uses three band classes A to C. UE 121 uses three band classes D to F. That is, UEs 111 and 121 use the same number of band classes for subsequent group calls.

Note that the three of six band classes A to F that each UE 100 uses can be determined using a group call ID or the like. For example, when a group call ID is identification information including a number, it may be predetermined that a UE 100 having a group call ID with a small number uses a band class having a high frequency (i.e., band classes A to C).

(3) Exemplary Variation

In communication system 1, an adjustment method different from the above adjustment method may be used. For example, a band class to be used when another group's call is detected may be predetermined for each rank For example, the adjustment can be done as follows:

UE 100 of rank A uses three band classes A to C, and UE 100 of rank B uses two band classes D and E. UE 100 of rank C uses one band class F. UEs 100 of ranks D to F stop their group calls.

### 5. Advantage

Communication system 1 according to the present embodiment can prevent interference among a plurality of group calls by previously defining a method of determining a frequency to be used when a group other than an own group which is making a group call is found, as described above. Furthermore, the system allows a resource for a frequency to be utilized efficiently. In other words, the system allows radio waves to be utilized efficiently.

Specifically, UE 100 with a higher priority can use a frequency band more preferentially than UE 100 with a lower priority. Furthermore, when UE 100 set high in priority does not exist, UE 100 with the lower priority can use a wider frequency band for a group call than when UE 100 set high in priority exists.

### 6. Sub Summary

A part of a characteristic processing of the above processing is summarized for example by focusing on UE 111, as follows:

(1) UE 111 is a device capable of making a group call by device-to-device communication without going through a base station. The group call is performed by selectively using at least one of a plurality of frequency bands. UE 111 comprises control unit 10, a memory (storage unit 20) having a predetermined rule (a predefined rule) stored therein, and a communication IF (communication unit 30).

When a group call is being made with UEs 112 and 113 and another group's call is also found, control unit 10 determines based on the predetermined rule a frequency band to be used for a subsequent group call with UEs 112 and 113. Control unit 10 notifies UEs 112 and 113 of the determined frequency band via the communication IF. Control unit 10 sets the frequency band to be used for the group call with UEs 112 and 113 to the determined frequency band.

(2) The memory stores a priority of a group call. Control unit 10 receives a first discovery signal via the communication IF through device-to-device communication from UE 121 of another group performing another group call. The first discovery signal includes the priority of the other group's call. Control unit 10 makes the above determination based on the priority of the group call and the priority of the other group's call.

(3) Control unit 10 transmits a second discovery signal to UE 121 of the other group through device-to-device communication via the communication IF. The second discovery signal includes the priority of the group call of interest.

### 7. Exemplary Variation

In the above description, a configuration has been described in which UE 100 that has detected another group's call notifies UE 100 in the same group of a frequency band (or band class) to be used for a subsequent group call. Hereinafter, a configuration will be described in which UE 100 that has detected another group's call does not notify UE 100 in the same group of a frequency band to be used for a subsequent group call. Specifically, a configuration will be described in which not only UE 100 that has detected another group's call but also UE 100 in the same group as UE 100 that has detected the other group's call are compared in priority or the like and a frequency to be used for a group call is changed based on a result of the comparison.

### (1) First Exemplary Variation

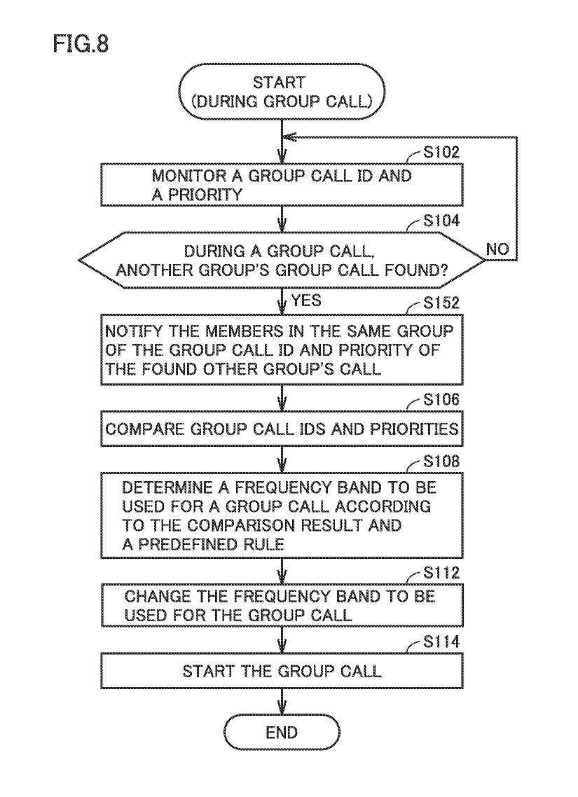

FIG. 8 is a flowchart for illustrating a flow of a processing of UE 111. FIG. 8 shows a flow of a series of processing steps, which differs from that indicated in FIG. 3 in that the former includes step S152 between step S104 and step S106 in FIG. 3 and excludes step S110.

In step S152, UE 100 notifies the members (UEs 100) in the same group as UP 100 of the group call ID and priority of the found other group's call. For example, UE 111 of the first group notifies UEs 112, 113 of the first group of the group call ID and priority of the found other group's call.

Each step in FIG. 8 other than step S152 has already been described, and accordingly, will not be described repeatedly.

### (2) Second Exemplary Variation

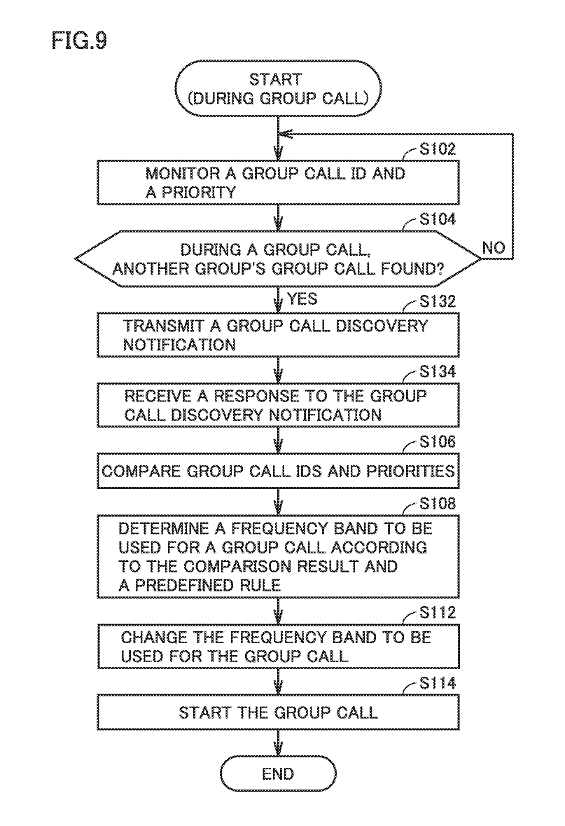

FIG. 9 is a flowchart for illustrating a flow of a processing of UE 111. FIG. 9 shows a flow of a series of processing steps, which differs from that indicated in FIG. 4 in that the former excludes step S110 shown in FIG. 4.

In step S132, UE 100 transmits the above-described group call discovery notification to at least UEs 100 of its own group. It should be noted that in step S132 UE 100 may transmit the group call discovery notification to UE 100 of a found other group. The other steps are the same as those shown in FIG. 4, and accordingly, will not be described repeatedly.

Note that when UE 100 transmits a group call discovery notification to UEs 100 of its own group, UE 100 includes the group call ID of the found other group and the priority of that other group in the group call discovery notification. The group call discovery notification may be transmitted by using a group call or by using a discovery signal.

Furthermore, when UE 100 transmits the group call discovery notification to UE 100 of the found other group, UE 100 includes in the group call discovery notification the group call ID of its own group and the priority of its own group as well as the group call ID of the found other group and the priority of the found other group. In that case, UE 100 transmits the group call discovery notification by using the discovery signal.

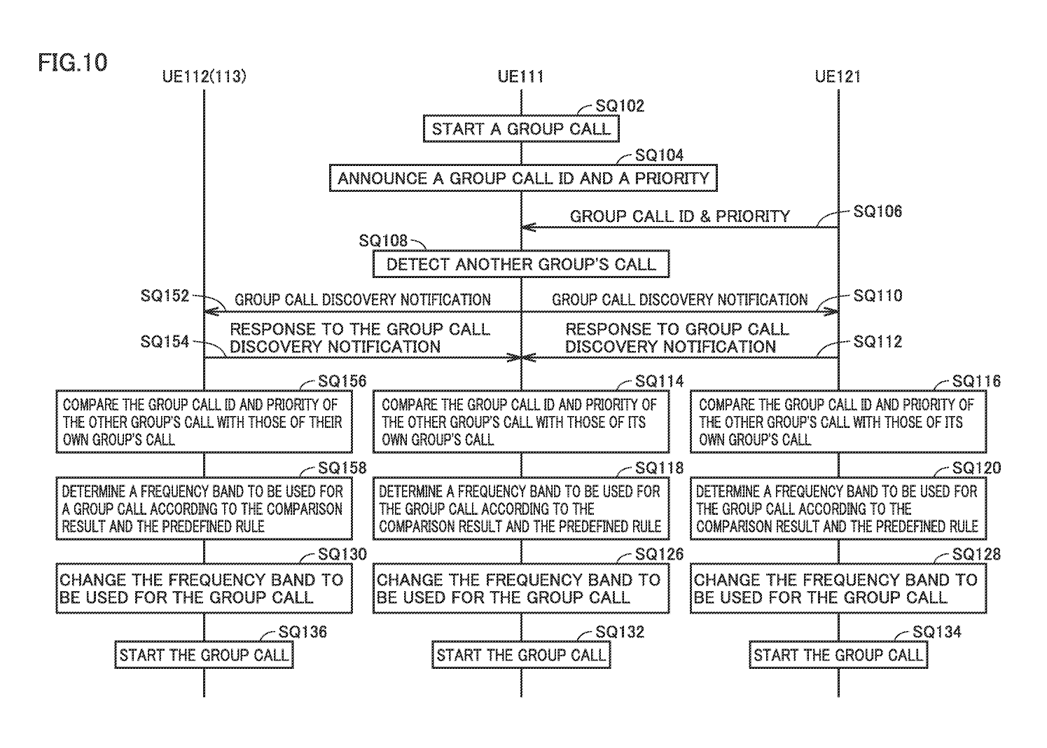

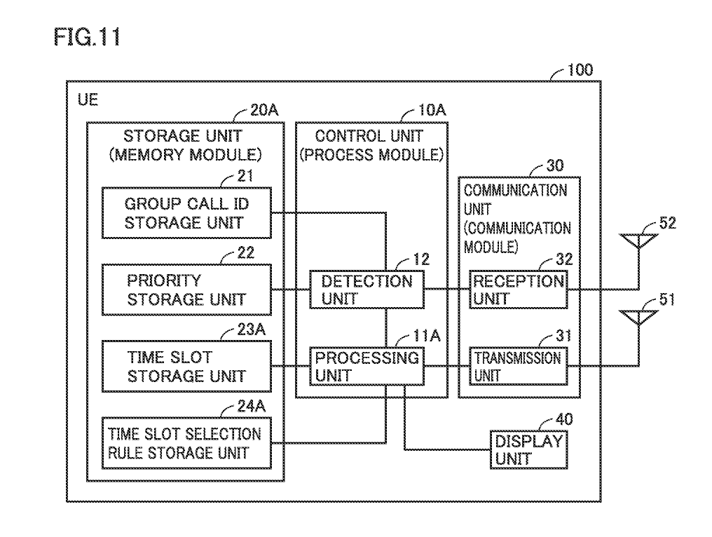

FIG. 10 is a sequence diagram for illustrating a flow of a processing in communication system 1 in an aspect. Specifically, FIG. 10 is a diagram for illustrating a sequence in a case where the processing indicated in FIG. 9 is performed in UE 111. Furthermore, in the following description, a configuration in which a group call discovery notification is also transmitted to UE 100 in another group will be described.

FIG. 10 shows a flow of a series of processing steps, which differs from that indicated in FIG. 5 in that the former further includes sequences SQ152, SQ154, SQ156, SQ158 and excludes sequences SQ122, SQ124. Accordingly, hereinafter, sequences SQ152, SQ154, SQ156, and SQ158 will be described.

In sequence SQ152, UE 111 transmits a group call discovery notification to UEs 112 and 113 of the first group. In sequence SQ154, UEs 112 and 113 respond to the group call discovery notification.

In sequence SQ156, UEs 112 and 113 compare the group call ID and priority of the other group's call with the group call ID and priority of their own group's call. In sequence SQ158, UEs 112 and 113 themselves determine a frequency to be used for a group call according to the comparison result and the predefined rule.

### Second Embodiment

In the first embodiment, a configuration has been described in which a frequency to be used for a group call is determined based on a result of comparing priorities or the like and a defined rule. In the present embodiment, a configuration will be described in which a time slot to be used for a group call is determined based on a result of comparing priorities or the like and a defined rule. Communication system 1 according to the present embodiment is generally identical in configuration to the first embodiment (see FIG. 1), and accordingly it will not be described repeatedly.

### 1. Functional Configuration

FIG. 11 is a block diagram for illustrating a functional configuration of UE 100 according to the present embodiment. With reference to FIG. 11, UE 100 comprises a control unit 10A, a storage unit 20A, communication unit 30, display unit 40, transmitting antenna 51, and receiving antenna 52. Control unit 10A includes a processing unit 11A and detection unit 12. Storage unit 20A includes group call ID storage unit 21, priority storage unit 22, a time slot storage unit 23A, and a time slot selection rule storage unit 24A. Typically, control unit 10A is configured as a process module. Typically, storage unit 20A is configured as a memory module.

UE 100 according to the present embodiment is different from UE 100 of the first embodiment comprising control unit 10 and storage unit 20 (see FIG. 2) in that the former comprises control unit 10A and storage unit 20A. More specifically, when UE 100 according to the present embodiment is compared with UE 100 according to the first embodiment, the former does not include frequency band storage unit 23 and frequency band selection rule storage unit 24 and instead includes time slot storage unit 23A and time slot selection rule storage unit 24A.

Control unit 10A is communicably connected to storage unit 20A and communication unit 30 by a bus or the like. Control unit 10A generally controls the operation of UE 100.

Time slot storage unit 23A has stored therein a time slot usable for device-to-device communication.

Time slot selection rule storage unit 24A has stored therein a rule applied in determining a time slot to be used or not to be used according to the above-described priorities. More specifically, time slot selection rule storage unit 24A has stored therein a rule (hereinafter also referred to as a “predefined rule”) applied in determining a time slot to be used or not to be used according to the above-described priorities when it is detected during a group call that another group (e.g., the second group) is making a group call within a range determined to affect a group call of the group of its own terminal (e.g., the first group). A specific example of the rule will be described later.

Processing unit 11A controls communications with another UE 100. Further, when detection unit 12 detects another communication, processing unit 11A selects a time slot (a communication resource) based on a time slot selection rule (a communication resource selection rule) stored in storage unit 20A. Further, processing unit II notifies the other UE 100 of information of the selected time slot (or communication resource) via communication unit 30.

More specifically, during a group call when another group's call is detected, processing unit 11A determines a time slot to be used for the group call based on the above predefined rule and a result of comparing the priority of the group call of its own terminal and that of the other group's call. Specifically, processing unit 11A determines the time slot to be used for the group call by applying the comparison result to the predefined rule. The time slot is specifically determined in a method which will be described later.

Furthermore, processing unit 11A announces the group call ID and priority of its own terminal stored in storage unit 20A to another UE 100 via transmission unit 31 and transmitting antenna 51. Specifically, processing unit 11A announces the group call ID and priority of its own terminal to the other UE 100 by using a D2D discovery signal during a group call.

### 2. Control Structure

(1) First Exemplary Processing

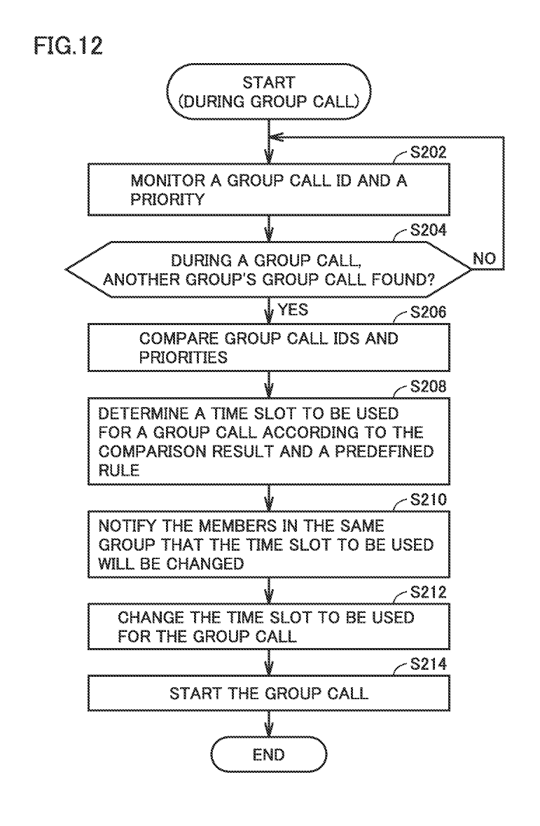

FIG. 12 is a flowchart for illustrating an example of a flow of a processing in UE 100. With reference to FIG. 12, steps S202, S204, and S206 are identical to steps S102, S104, and S106 described in the first embodiment (see FIG. 3), and accordingly, will not be described repeatedly.

In step S208, UE 100 determines a time slot to be used for a group call according to the comparison result and the above predefined rule. In step S210, when the determined time slot is different from the currently used time slot, UE 100 notifies the members in the same group as UE 100 (that is, the UEs 100 belonging to the same group) that the time slot to be used will be changed. In step S212, UE 100 changes (sets) the time slot to be used for the group call to the determined time slot. In step S214, UE 100 uses the changed time slot to start (or resume) the group call with UE 100 belonging to the group.

(2) Second Exemplary Processing

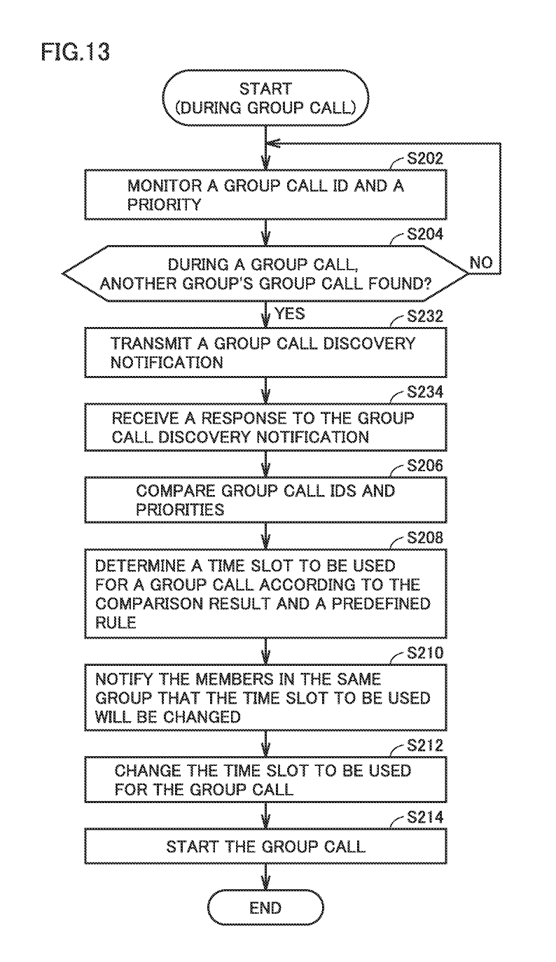

FIG. 13 is a flowchart for illustrating another example of a flow of a processing in UE 100. FIG. 13 indicates a second exemplary processing, which differs from the first exemplary processing indicated in FIG. 12 in that the former includes steps S232 and S234 between step S204 and step S206 indicated in FIG. 12. Furthermore, steps S232 and S234 are identical to steps S132 and 134 described in the first embodiment (see FIG. 4). Accordingly each step in FIG. 13 will not be described repeatedly. It should be noted that UE 100 may be configured so as to perform step S206 without performing step S234.

Furthermore, UE 100 may transmit the above-described group call discovery notification to UE 100 of its own group, or may transmit the group call discovery notification to UE 100 of a found other group.

When UE 100 transmits a group call discovery notification to UE 100 of its own group, UE 100 includes the group call ID of the found other group and the priority of that other group in the group call discovery notification. The group call discovery notification may be transmitted by using a group call or by using a discovery signal.

When UE 100 transmits a group call discovery notification to UE 100 of the found other group, UE 100 includes in the group call discovery notification the group call ID of its own group and the priority of its own group as well as the group call ID of the found other group and the priority of the found other group. In that case, UE 100 transmits the group call discovery notification by using the discovery signal,

(3) Sequence in the Case of the Second Exemplary Processing

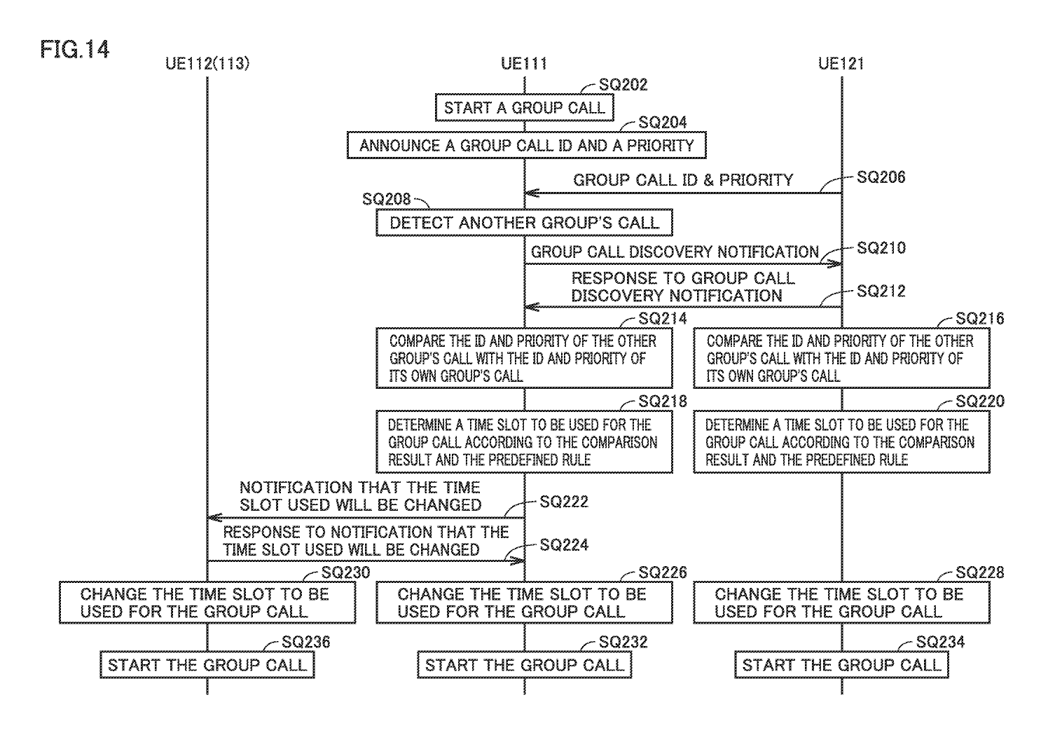

FIG. 14 is a sequence diagram for illustrating a flow of a processing in communication system 1 in an aspect. Specifically, FIG. 14 is a diagram for illustrating a sequence in a case where a processing based on the above-described second exemplary processing is performed in UE 111. Hereinafter, a configuration in which a group call discovery notification is transmitted to UE 100 of another group will be described.

With reference to FIG. 14, sequences SQ202, SQ204, SQ206, SQ208, SQ210, SQ212, SQ214, and SQ216, are identical to sequences SQ102, SQ104, SQ106, SQ108, SQ110, SQ112, SQ114, and SQ116, respectively, described in the first embodiment (see FIG. 5), and accordingly, they will not be described repeatedly.

In a sequence SQ218, UE 111 determines a time slot to be used tor the group call of its own group (i.e., the first group) according to the comparison result and the predetermined rule. In a sequence SQ220, UE 121 determines a time slot to be used for the group call of its own group (i.e., the second group) according to the comparison result and the predetermined rule.

In a sequence SQ222, in order to set the time slot determined by UE 111 to be a time slot used for a subsequent group call, UE 111 notifies UEs 112 and 113 in the same group as UE 111 that the time slot used for the group call will be changed. More specifically, UE 111 transmits an instruction to UEs 112 and 113 for causing them to use the determined time slot. In a sequence SQ224, in response to the notification indicating that the time slot will be changed, UEs 112 and 113 return a response to UE 111.

In a sequence SQ226, UE 111 changes the time slot to be used for its group call to the time slot determined in sequence SQ218. In a sequence SQ228, UE 121 changes the time slot to be used for its group call to the time slot determined in sequence SQ220. In a sequence SQ230, UEs 112, 113 change the time slot to be used for their group call to the time slot that the UEs are notified of in sequence SQ222.

In a sequence SQ232, UE 111 starts (or resumes) its group call using its changed time slot. In a sequence SQ234, UE 121 starts (or resumes) its group call using its changed time slot. In a sequence SQ236, UEs 112, 113 start (or resume) their group call using their changed time slot.

### 3. Data

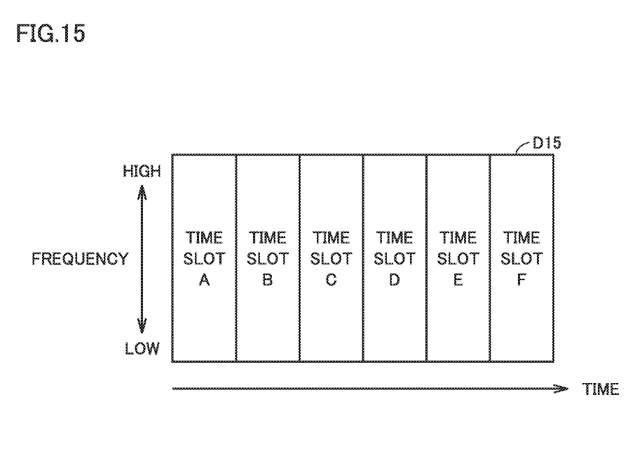

FIG. 15 is a conceptual diagram of a time slot table D15 defining a time slot usable for a group call. Referring to FIG. 15, in time slot table D15, six slots are defined as time slots. Specifically, a time slot A, a time slot B, a time slot C, a time slot D, a time slot E, and a time slot F are defined in a temporal order in a determined frequency band. Typically, time slots A to F have the same time length.

Note that time slot table D15 is an example, and the number and classification of time slots are not limited to the above. Hereinafter, a method of determining a time slot to be used will be described for different cases.

(1) When Group Calls of Different Ranks are Detected

(i) Adjustment Between Group Call of Rank A and Group Call of Rank B

For example, when UE 111 has a priority of rank A and UE 121 has a priority of rank B, and UEs 111 and 121 each receive an announcement of a priority from the other UE, a time slot to be used for a subsequent group call is determined, as follows:

UE 111 of rank A uses four time slots A to D. UE 121 of rank B having a priority lower than rank A uses two time slots E and F.

Whenever UE 100 receives an announcement of a group call ID and a priority, the above processing is performed by UE 100 that has received the announcement. It should be noted that the same applies to a case of another adjustment described below.

(ii) Adjustment Between Group Call of Rank A and Group Call of Rank E

For example, when UE 111 has a priority of rank A and UE 121 has a priority of rank E, and UEs 111 and 121 each receive an announcement of a priority from the other UE, a time slot to be used for a subsequent group call is determined, as follows:

UE 111 of rank A uses five time slots A to E. UE 121 of rank E having a priority lower than rank A uses one time slot F.

As a difference in priority between rank A and rank E is larger than a difference in priority between rank A and rank B, the number of time slots used by UE 121 is reduced to be smaller in the case of rank E of a group call of UE 121 than in the case of rank B thereof.

(iii) Adjustment Between Group Call of Rank A and Group Call of Rank F

For example, when UE 111 has a priority of rank A and UE 121 has a priority of rank F, and UEs 111 and 121 each receive an announcement of a priority from the other UE, a time slot to be used for a subsequent group call is determined, as follows:

UE 111 of rank A uses all time slots A to UE 121 of rank F stops its group call. That is, for rank F, UE 100 does not allocate a time slot to a group call.

As a difference in priority between rank A and rank F is larger than a difference in priority between rank A and rank E, the number of time slots used by UE 111 is increased to be larger in the case of rank F of a group call of UE 121 than in the case of rank E thereof.

### (2) When Group Calls Having the Same Rank are Detected

For example, when UE 111 has a priority of rank B and UE 121 has a priority of rank B, and UEs 111 and 121 each receive an announcement of a priority from the other UE, a time slot to be used for a subsequent group call is determined, as follows:

UE 111 uses three time slots A to C. UE 121 uses three time slots D to F. That is, UEs 111 and 121 use the same number of time slots for subsequent group calls.

Note that the three of six time slots A to F that each UE 100 uses can be determined using a group call ID or the like. For example, when a group call ID is identification information including a number, it may be predetermined that a UE 100 having a group call ID with a small number uses a temporally preceding time slot (i.e., time slots A to C).

### (3) Exemplary Variation

In communication system 1, an adjustment method different from the above adjustment method may be used. For example, a time slot to be used when another group's call is detected may be predetermined for each rank. For example, the adjustment can be done as follows:

UE 100 of rank A uses three time slots A to C, and OF 100 of rank B uses two time slots D and E. UE 100 of rank C uses one time slot F. UEs 100 of ranks D to F stop their group calls.

### 4. Advantage

Communication system 1 according to the present embodiment can prevent interference among a plurality of group calls by previously defining a method of determining a time slot to be used when a group other than an own group which is making a group call is found, as described above. Furthermore, the system allows a resource for a time slot to be utilized efficiently. In other words, the system allows radio waves to be utilized efficiently.

Specifically, UE 100 with a higher priority can use a time slot more preferentially than UE 100 with a lower priority. Furthermore, when UE 100 set high in priority does not exist, UE 100 with the lower priority can use a resource of a longer time for a group call than when UE 100 set high in priority exists.

### 5. Sub Summary

A part of a characteristic processing of the above processing is summarized for example by focusing on UE 111, as follows:

UE 111 is a device capable of making a group call by device-to-device communication without going through a base station. The group call is performed by selectively using at least one of a plurality of time slots. UE 111 comprises control unit 10A, a memory (storage unit 20A) having a predetermined rule (a predefined rule) stored therein, and a communication IF (communication unit 30).

When a group call is being made with UEs 112 and 113 and another group's call is also found, control unit 10A determines based on the predetermined rule a time slot to be used for a subsequent group call with UEs 112 and 113. Control unit 10A notifies UEs 112 and 113 of the determined time slot via the communication IF. Control unit 10A sets the time slot to be used for the group call with UEs 112 and 113 to the determined frequency band.

### 6. Exemplary Variation

In the above description, a configuration has been described in which UE 100 that has detected another group's call notifies UE 100 in the same group of a time slot to be used for a subsequent group call. Hereinafter, a configuration will be described in which UE 100 that has detected another group's call does not notify UE 100 in the same group of a time slot to be used for a subsequent group call. Specifically, a configuration will be described in which not only UE 100 that has detected another group's call but also UE 100 in the same group as UE 100 that has detected the other group's call are compared in priority or the like and a time slot to be used for a group call is changed based on a result of the comparison.

(1) First Exemplary Variation

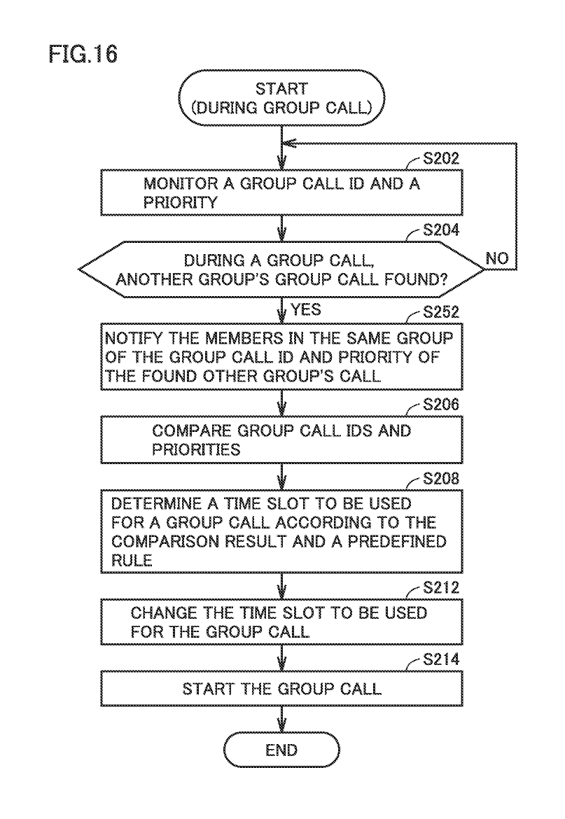

FIG. 16 is a flowchart for illustrating a flow of a processing of UE 111. FIG. 16 shows a flow of a series of processing steps, which differs from that indicated in FIG. 12 in that the former includes step S252 between step S204 and step S206 in FIG. 12 and excludes step S210.

In step S252, UE 100 notifies the members (UEs 100) in the same group as UE 100 of the group call ID and priority of a found other group's call. For example, UE 111 of the first group notifies UEs 112, 113 of the first group of the group call ID and priority of the found other group's call.

Each step in FIG. 16 other than step S252 has already been described, and accordingly, will not be described repeatedly.

### (2) Second Exemplary Variation

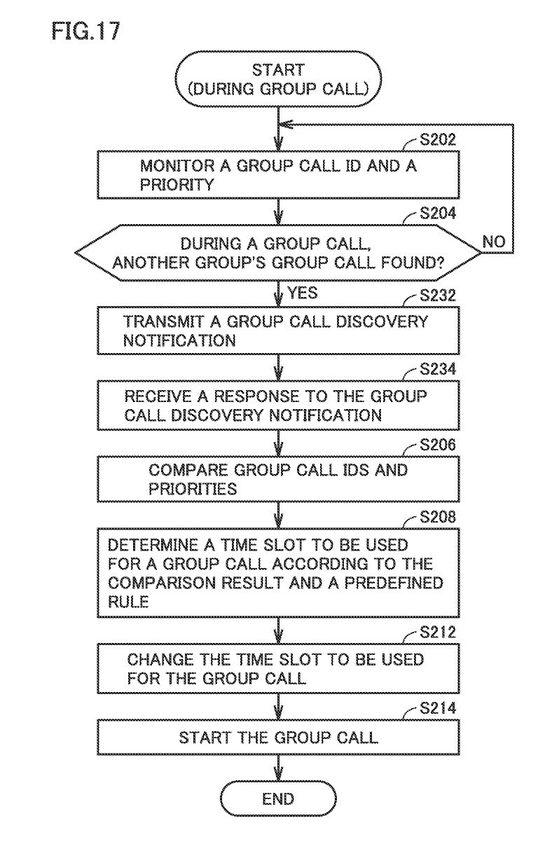

FIG. 17 is a flowchart for illustrating a flow of a processing of UE 111. FIG. 17 shows a flow of a series of processing steps, which differs from that indicated in FIG. 13 in that the former excludes step S210 shown in FIG. 13.

In step S232, UE 100 transmits the above-described group call discovery notification to at least UEs 100 of its own group. It should be noted that in step S232 UE 100 may transmit the group call discovery notification to UE 100 of a found other group. The other steps are the same as those shown in FIG. 13, and accordingly, will not be described repeatedly.

Note that when UE 100 transmits a group call discovery notification to UEs 100 of its own group, UE 100 includes the group call ID of the found other group and the priority of that other group in the group call discovery notification. The group call discovery notification may be transmitted by using a group call or by using a discovery signal.

Furthermore, when. UE 100 transmits the group call discovery notification to UE 100 of the found other group, UE 100 includes in the group call discovery notification the group call ID of its own group and the priority of its own group as well as the group call ID of the found other group and the priority of the found other group. In that case, UE 100 transmits the group call discovery notification by using the discovery signal.

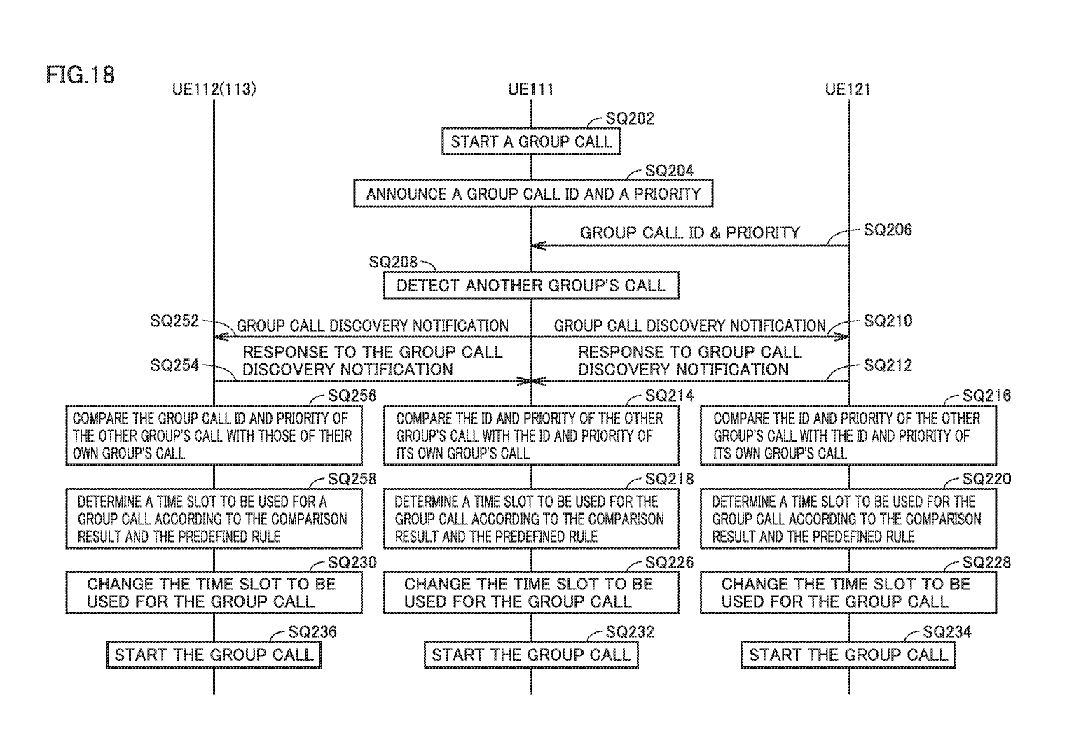

FIG. 18 is a sequence diagram for illustrating a flow of a processing in communication system 1 in an aspect. Specifically, FIG. 18 is a diagram for illustrating a sequence in a case where the processing indicated in FIG. 17 is performed in UE 111. Furthermore, in the following description, a configuration in which a group call discovery notification is also transmitted to UE 100 in another group will be described.

FIG. 18 shows a flow of a series of processing steps, which differs from that indicated in FIG. 14 in that the former further includes sequences SQ252, SQ254, SQ256, SQ258 and excludes sequences SQ222, SQ224. Accordingly, hereinafter, sequences SQ252, SQ254, SQ256, SQ258 will be described.

In sequence SQ252, UE 111 transmits a group call discovery notification to UEs 112 and 113 of the first group. In sequence SQ254, UEs 112 and 113 respond to the group call discovery notification.

In sequence SQ256, UEs 112 and 113 compare the group call ID and priority of the other group's call with the group call ID and priority of their own group's call. In sequence SQ258, UEs 112 and 113 themselves determine a time slot to be used for a group call according to the comparison result and the predefined rule.

### Third Embodiment

In the present embodiment, a configuration will be described in which a resource block to be used for a group call is determined based on a result of comparing priorities or the like and a defined rule. Communication system 1 according to the present embodiment is generally identical in configuration to the first embodiment (see FIG. 1), and accordingly it will not be described repeatedly.

### 1. Functional Configuration

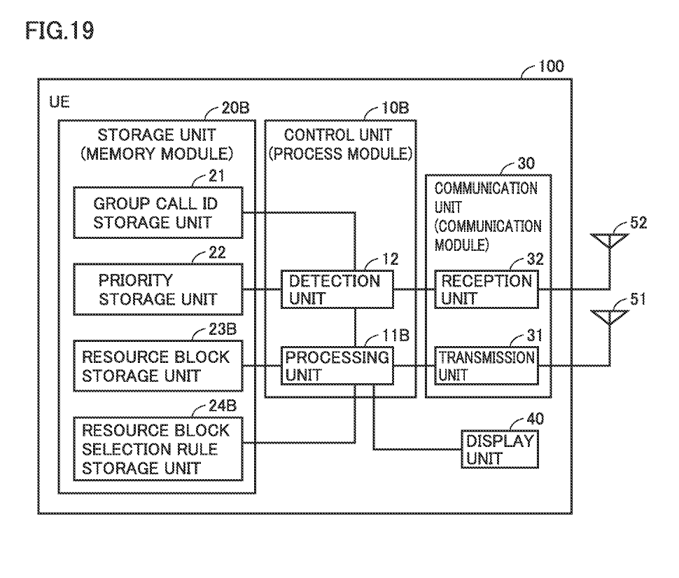

FIG. 19 is a block diagram for illustrating a functional configuration of UE 100 according to the present embodiment. With reference to FIG. 11, UE 100 comprises a control unit 10B, a storage unit 20B, communication unit 30, display unit 40, transmitting antenna 51, and receiving antenna 52. Control unit 109 includes a processing unit 11B and detection unit 12. Storage unit 20B includes group call ID storage unit 21, priority storage unit 22, a resource block storage unit 239, and a resource block selection rule storage unit 24B. Typically, control unit 10B is configured as a process module. Typically, storage unit 20B is configured as a memory module.

UE 100 according to the present embodiment is different from UE 100 of the first embodiment comprising control unit 10 and storage unit 20 (see FIG. 2) in that the former comprises control unit 10B and storage unit 20B. More specifically, when UE 100 according to the present embodiment is compared with UE 100 according to the first embodiment, the former does not include frequency band storage unit 23 and frequency band selection rule storage unit 24 and instead includes resource block storage unit 23B and resource block selection rule storage unit 24B.

Control unit 10B is communicably connected to storage unit 20B and communication unit 30 by a bus or the like. Control unit 10B generally controls the operation of UE 100.

Resource block storage unit 23B has stored therein a resource block usable for device-to-device communication.

Resource block selection rule storage unit 24B has stored therein rule applied in determining a resource block to be used or not to be used according to the above-described priorities. More specifically, resource block selection rule storage unit 24B has stored therein a rule applied in determining a resource block to be used or not to be used according to the above-described priorities when it is detected during a group call that another group (e.g., the second group) is making a group call within a range determined to affect a group call of the group of its own terminal (e.g., the first group) (hereinafter also referred to as a “predefined rule”). A specific example of the rule will be described later.

Processing unit 11B controls communications with another UE 100. Further, when detection unit 12 detects another communication, processing unit 11B selects a resource block (a communication resource) based on a resource block selection rule (a communication resource selection rule) stored in storage unit 20B. Further, processing unit 11 notifies the other UE 100 of information of the selected resource block (or communication resource) via communication unit 30.

More specifically, during a group call when another group's call is detected, processing unit 11B determines a resource block to be used for the group call based on the above predefined rule and a result of comparing the priority of the group call of its own terminal and that of the other group's call. Specifically, processing unit 11B determines the resource block to be used for the group call by applying the comparison result to the predefined rule. The resource block is specifically determined in a method which will be described later.

Furthermore, processing unit 11B announces the group call ID and priority of its own terminal stored in storage unit 20B to another UE 100 via transmission unit 31 and transmitting antenna 51. Specifically, processing unit 11B announces the group call ID and priority of its own terminal to the other UE 100 by using a D2D discovery signal during a group call.

### 2.Control Structure

(1) First Exemplary Processing

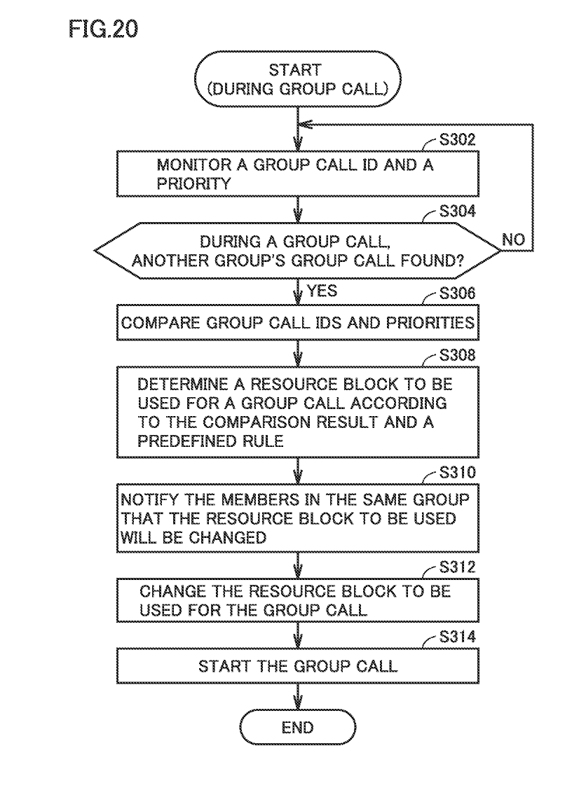

FIG. 20 is a flowchart for illustrating an example of a flow of a processing in UE 100. With reference to FIG. 20, steps S302, S304, and S306 are identical to steps S102, S104, and S106 described in the first embodiment (see FIG. 3), and accordingly, will not be described repeatedly.

In step S308, UE 100 determines a resource block to be used for a group call according to the comparison result and the above predefined rule. In step S310, when the determined resource block is different from the currently used resource block, UE 100 notifies the members in the same group as UE 100 (that is, the UEs 100 belonging to the same group) that the resource block to be used will be changed. In step S312, UE 100 changes (sets) the resource block to be used for the group call to the determined resource block. In step S314, UE 100 uses the changed resource block to start (or resume) the group call with UE 100 belonging to the group.

(2) Second Exemplary Processing

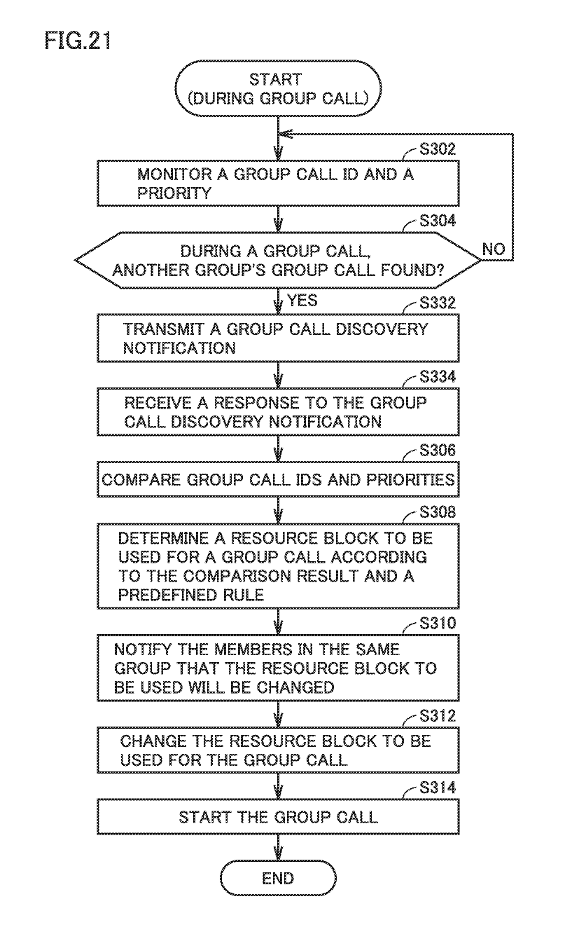

FIG. 21 is a flowchart for illustrating another example of a flow of a processing in UE 100. FIG. 21 indicates a second exemplary processing, which differs from the first exemplary processing indicated in FIG. 20 in that the former includes steps S332 and S334 between step S304 and step S306 indicated in 20. Furthermore, steps S332 and S334 are identical to steps S132 and 134 described in the first embodiment (see FIG. 4). Accordingly each step in FIG. 21 will not be described repeatedly. It should be noted that UE 100 may be configured so as to perform step S306 without performing step S334.

Furthermore, UE 100 may transmit the above-described group call discovery notification to UE 100 of its own group, or may transmit the group call discovery notification to UE 100 of a found other group.

When UE 100 transmits a group call discovery notification to UE 100 of its own group, UE 100 includes the group call ID of the found other group and the priority of that other group in the group call discovery notification. The group call discovery notification may be transmitted by using a group call or by using a discovery signal.

When UE 100 transmits a group call discovery notification to UE 100 of the found other group, UE 100 includes in the group call discovery notification the group call ID of its own group and the priority of its own group as well as the group call ID of the found other group and the priority of the found other group. In that case, UE 100 transmits the group call discovery notification by using the discovery signal.

(3) Sequence in the Case of the Second Exemplary Processing

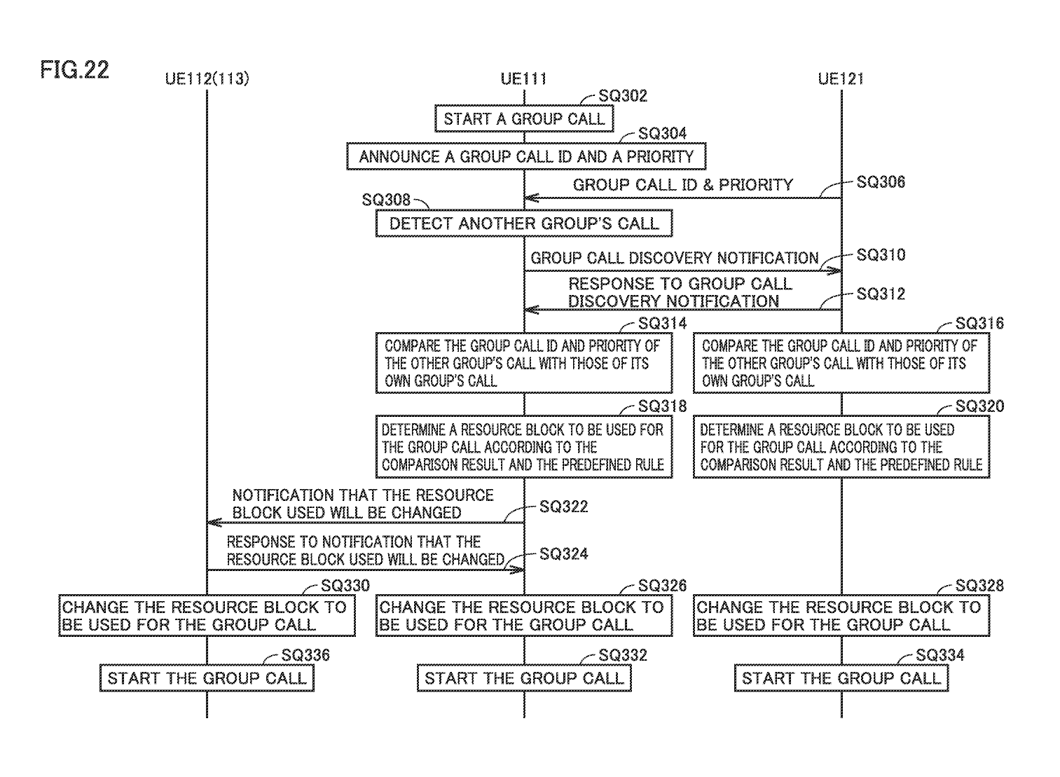

FIG. 22 is a sequence diagram for illustrating a flow of a processing in communication system 1 in an aspect. Specifically, FIG. 22 is a diagram for illustrating a sequence in a case where a processing based on the above-described second exemplary processing is performed in UE 111. Hereinafter, a configuration in which a group call discovery notification is transmitted to UE 100 of another group will be described.

With reference to FIG. 22, sequences SQ302, SQ304, SQ306, SQ308, SQ310, SQ312, SQ314, and SQ316, are identical to sequences SQ102, SQ104, SQ106, SQ108, SQ110, SQ112, SQ114, and SQ116, respectively, described in the first embodiment (see FIG. 5), and accordingly, they will not be described repeatedly.

In a sequence SQ318, UE 111 determines a resource block to be used for the group call of its own group (i.e., the first group) according to the comparison result and the predetermined rule. In a sequence SQ320, UE 121 determines a resource block to be used for the group call of its own group (i.e., the second group) according to the comparison result and the predetermined rule.

In a sequence SQ322, in order to set the resource block determined by UE 111 to be a resource block used for a subsequent group call, UE 111 notifies UEs 112 and 113 in the same group as UE 111 that the resource block used for the group call will be changed. More specifically, UE 111 transmits an instruction to UEs 112 and 113 for causing them to use the determined resource block. Ina sequence SQ324, in response to the notification indicating that the resource block will be changed, UEs 112 and 113 return a response to UE 111.

In a sequence SQ326, UE 111 changes the resource block to be used for its group call to the resource block determined in sequence SQ318. In a sequence SQ328, UE 121 changes the resource block to be used for its group call to the resource block determined in sequence SQ320. In a sequence SQ330, UEs 112, 113 change the resource block to be used for their group call to the resource block that the UEs are notified of in sequence SQ322.

In a sequence SQ332, UE 111 starts (or resumes) its group call using its changed resource block. In a sequence SQ334, UE 121 starts (or resumes) its group call using its changed resource block. In a sequence SQ336, UEs 112, 113 start (or resume) their group call using their changed resource block.

### 3. Data

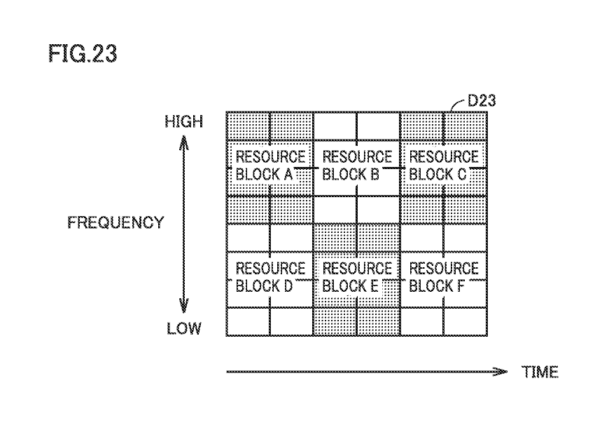

FIG. 23 is a conceptual diagram of a resource block table D23 defining a resource block usable for a group call. Referring to FIG. 23, in resource block table D23, six blocks are defined as resource blocks.

Specifically, a resource block A, a resource block B, a resource block C, a resource block D, a resource block E, and a resource block F are defined for sections of frequency bands and time zones. Typically, resource blocks A to F have the same time length. Typically, resource blocks A to C have equal frequency bands. Resource blocks D to F have equal frequency bands. The frequency bands of resource blocks A to C and those of resource blocks D to F are different.

Note that resource block table D23 is an example, and the number and classification of resource blocks are not limited to the above. Hereinafter, a method of determining a resource block to be used will be described for different cases.

(1) When Group Calls of Different Ranks are Detected (i) Adjustment Between Group Call of Rank A and Group Call of Rank B

For example, when UE 111 has a priority of rank A and UE 121 has a priority of rank B, and UEs 111 and 121 each receive an announcement of a priority from the other UE, a resource block to be used for a subsequent group call is determined, as follows:

UE 111 of rank A uses four resource blocks A to D. UE 121 of rank B having a priority lower than rank A uses two resource blocks E and F.

Whenever UE 100 receives an announcement of a group call ID and a priority, the above processing is performed by UE 100 that has received the announcement. It should be noted that the same applies to a case of another adjustment described below.

(ii) Adjustment Between Group Call of Rank A and Group Call of Rank E

For example, when UE 111 has a priority of rank A and UE 121 has a priority of rank E, and UEs 111 and 121 each receive an announcement of a priority from the other UE, a resource block to be used for a subsequent group call is determined, as follows:

UE 111 of rank A uses five resource blocks A to E. UE 121 of rank E having a priority lower than rank A uses one resource block F.

As a difference in priority between rank A and rank E is larger than a difference in priority between rank A and rank B, the number of resource blocks used by UE 121 is reduced to be smaller in the case of rank E of a group call of UE 121 than in the case of rank B thereof.

(iii) Adjustment Between Group Call of Rank A and Group Call of Rank F

For example, when UE 111 has a priority of rank A and UE 121 has a priority of rank F, and UEs 111 and 121 each receive an announcement of a priority from the other UE, a resource block to be used for a subsequent group call is determined, as follows:

UE 111 of rank A uses all resource blocks A to F. UE 121 of rank F stops its group call. That is, for rank F, UE 100 does not allocate a resource block to a group call.

As a difference in priority between rank A and rank F is larger than a difference in priority between rank A and rank E, the number of resource blocks used by UE 111 is increased to be larger in the case of rank F of a group call of UE 121 than in the case of rank E.

(2) When Group Calls Having the Same Rank are Detected

For example, when UE 111 has a priority of rank B and UE 121 has a priority of rank B, and UEs 111 and 121 each receive an announcement of a priority from the other UE, a resource block to be used for a subsequent group call is determined, as follows:

UE 111 uses three resource blocks A to C. UE 121 uses three resource blocks D to F. That is, UEs 111 and 121 use the same number of resource blocks for subsequent group calls.

Note that the three of six resource blocks A to F that each UE 100 uses can be determined using a group call ID or the like. For example, when a group call ID is identification information including a number, it may be predetermined that a UE 100 having a group call ID with a small number uses a resource block having a high frequency band (i.e., resource blocks A to C).

(3) Exemplary Variation

In communication system 1, an adjustment method different from the above adjustment method may be used. For example, a resource block to be used when another group's call is detected may be predetermined for each rank. For example, the adjustment can be done as follows:

UE 100 of rank A uses three resource blocks A to C, and UE 100 of rank B uses two resource blocks D and E. UE 100 of rank C uses one resource block UEs 100 of ranks D to F stop their group calls.

### 4. Advantage

Communication system 1 according to the present embodiment can prevent interference among a plurality of group calls by previously defining a method of determining a resource block to be used when a group other than an own group which is making a group call is found, as described above. Furthermore, the system allows a resource block to be utilized efficiently. In other words, the system allows radio waves to be utilized efficiently.

Specifically, UE 100 with a higher priority can use a resource block more preferentially than UE 100 with a lower priority. Furthermore, when UE 100 set high in priority does not exist, UE 100 with the lower priority can use more radio resources for a group call than when UE 100 set high in priority exists.

### 5. Sub Summary

A part of a characteristic processing of the above processing is summarized for example by focusing on UE 111, as follows:

UE 111 is a device capable of making a group call by device-to-device communication without going through a base station. The group call is performed by selectively using at least one of a plurality of resource blocks. UE 111 comprises control unit 109, a memory (storage unit 209) having a predetermined rule (a predefined rule) stored therein, and a communication IF (communication unit 30).

When a group call is being made with UEs 112 and 113 and another group's call is also found, control unit 10B determines based on the predetermined rule a resource block to be used for a subsequent group call with UEs 112 and 113. Control unit 10B notifies UEs 112 and 113 of the determined resource block via the communication IF. Control unit 10B sets the resource block to be used for the group call with UEs 112 and 113 to the determined frequency band.

### 6. Exemplary Variation

In the above description, a configuration has been described in which UE 100 that has detected another group's call notifies UE 100 in the same group of a resource block to be used for a subsequent group call. Hereinafter, a configuration will be described in which UE 100 that has detected another group's call does not notify UE 100 in the same group of a resource block to be used for a subsequent group call. Specifically, a configuration will be described in which not only UE 100 that has detected another group's call but also UE 100 in the same group ac UE 100 that has detected the other group's call are compared in priority or the like and a resource block to be used for a group call is changed based on a result of the comparison.

(1) First Exemplary Variation

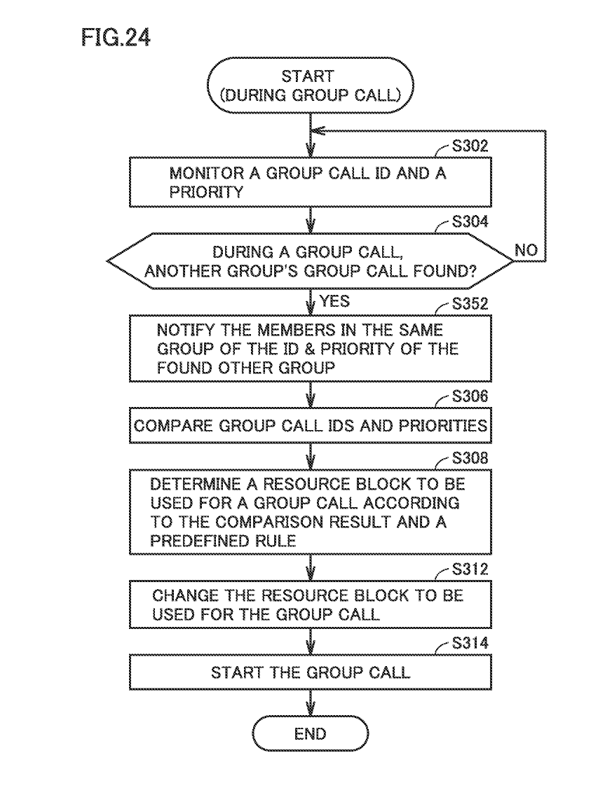

FIG. 24 is a flowchart for illustrating a flow of a processing of UE 111. FIG. 24 shows a flow of a series of processing steps, which differs from that indicated in FIG. 20 in that the former includes step S352 between step S304 and step S306 in FIG. 20 and excludes step S310.

In step S352, UE 100 notifies the members (UEs 100) in the same group as UE 100 of the group call ID and priority of a found other group's call. For example, UE 111 of the first group notifies UEs 112, 113 of the first group of the group call ID and priority of the found other group's call.

Each step in FIG. 24 other than step S352 has already been described, and accordingly, will not be described repeatedly.

(2) Second Exemplary Variation

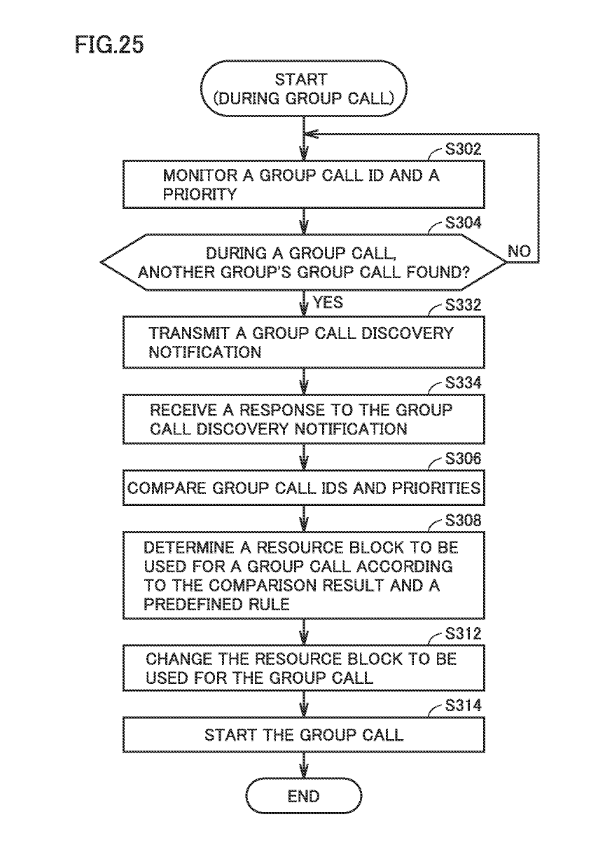

FIG. 25 is a flowchart for illustrating a flow of a processing of UE 111. FIG. 25 shows a flow of a series of processing steps, which differs from that indicated in FIG. 21 in that the fanner excludes step S310 shown in FIG. 21.

In step S332, UE 100 transmits the above-described group call discovery notification to at least UEs 100 of its own group. It should be noted that in step S332 UE 100 may transmit the group call discovery notification to UE 100 of a found other group. The other steps are the same as those shown in FIG. 21, and accordingly, will not be described repeatedly.

Note that when UE 100 transmits a group call discovery notification to UEs 100 of its own group, UE 100 includes the group call ID of the found other group and the priority of that other group in the group call discovery notification. The group call discovery notification may be transmitted by using a group call or by using a discovery signal.

Furthermore, when UE 100 transmits the group call discovery notification to UE 100 of the found other group, UE 100 includes in the group call discovery notification the group call ID of its own group and the priority of its own group as well as the group call ID of the found other group and the priority of the found other group. In that case, UE 100 transmits the group call discovery notification by using the discovery signal.

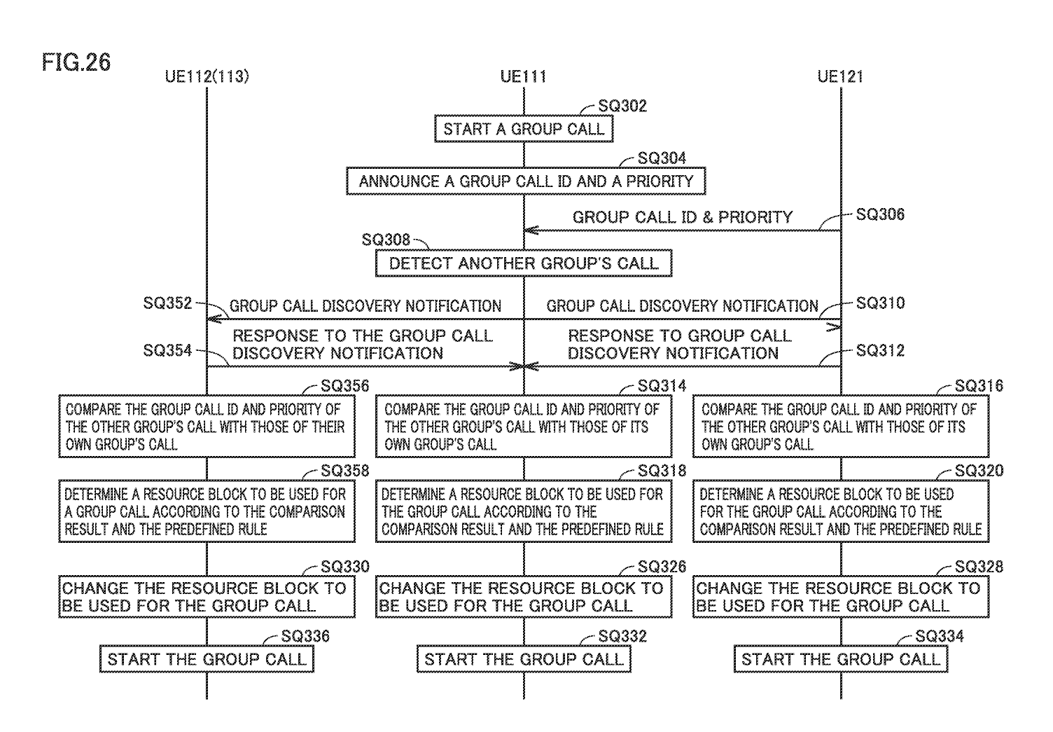

FIG. 26 is a sequence diagram for illustrating a flow of a processing in communication system 1 in an aspect. Specifically, FIG. 26 is a diagram for illustrating a sequence in a case where the processing indicated in FIG. 25 is performed in UE 111. Furthermore, in the following description, a configuration in which a group call discovery notification is also transmitted to UE 100 in another group will be described.

FIG. 26 shows a flow of a series of processing steps, which differs from that indicated in FIG. 22 in that the former further includes sequences SQ352, SQ354, SQ356, SQ358 and excludes sequences SQ322, SQ324. Accordingly, hereinafter, sequences SQ352, SQ354, SQ356, SQ358 will be described.

In sequence SQ352, UE 111 transmits a group call discovery notification to UEs 112 and 113 of the first group. In sequence SQ354, UEs 112 and 113 respond to the group call discovery notification.

In sequence SQ356, UEs 112 and 113 compare the group call ID and priority of the other group's call with the group call ID and priority of their own group's call. In sequence SQ358, UEs 112 and 113 themselves determine a resource block to be used for a group call according to the comparison result and the predefined rule.

### Fourth Embodiment

In the first to third embodiments, a configuration has been described in which a group call ID of another group's call is obtained from an announcement done by UE 100 of the other group. In the present embodiment, a configuration in which a group call ID of another group's call is previously stored will be described. Communication system 1 according to the present embodiment is generally identical in configuration to the first embodiment (see FIG. 1), and accordingly it will not be described repeatedly.

1. Functional Configuration

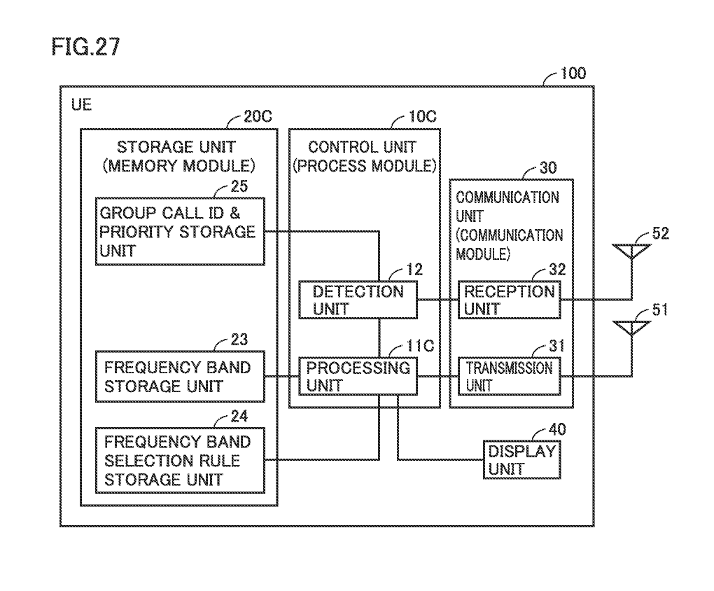

FIG. 27 is a block diagram for illustrating a functional configuration of UE 100 according to the present embodiment. With reference to FIG. 27, UE 100 comprises a control unit 10C, a storage unit 20C, communication unit 30, display unit 40, transmitting antenna 51, and receiving antenna 52. Control unit 10C includes a processing unit 11C and detection unit 12. Storage unit 20C includes a group call ID and priority storage unit 25, frequency band storage unit 23, and frequency band selection rule storage unit 24. Typically, control unit 10C is configured as a process module. Typically, storage unit 20C is configured as a memory module.

UE 100 according to the present embodiment is different from UE 100 of the first embodiment comprising control unit 10 and storage unit 20 (see FIG. 2) in that the former comprises control unit 10C and storage unit 20C. More specifically, when UE 100 according to the present embodiment is compared with UE 100 according to the first embodiment, the former does not include group call ID storage unit 21 and priority storage unit 22 and instead includes group call ID and priority storage unit 25.

Control unit 10C is communicably connected to storage unit 20C and communication unit 30 by a bus or the like. Control unit 10C generally controls the operation of UE 100.

Group call ID and priority storage unit 25 has stored therein a group call ID of its own group, a group call ID of another group, and a priority of each group call. One UE 100 may have a plurality of group call IDs so that the UE can participate in a plurality of group calls.

Processing unit 11C controls communications with another UE 100. Further, when detection unit 12 detects another communication, processing unit 11C selects a frequency band (a communication resource) based on a frequency band selection rule (a communication resource selection rule) stored in storage unit 20C. Further, processing unit 11C notifies the other UE 100 of information of the selected frequency band (or communication resource) via communication unit 30.

More specifically, during a group call when another group's call is detected, processing unit 11C determines a frequency to be used for the group call based on the above predefined rule and a result of comparing the priority of the group call of its own terminal and that of the other group's call. Specifically, processing unit 11C determines the frequency to be used for the group call by applying the comparison result to the predefined rule. The frequency is specifically determined in the same method as has been described in the first embodiment with reference to FIGS. 6 and 7, and accordingly, the method will be described repeatedly.

Furthermore, processing unit I IC announces the group call ID of its own terminal stored in storage unit 20C to another UE 100 via transmission unit 31 and transmitting antenna 51. Specifically, processing unit 11C announces the group call ID of its own terminal to the other UE 100 by using a D2D discovery signal during a group call. Note, however, that in contrast to the first to third embodiments, in the present embodiment, processing unit 11C does not announce to the other UE 100 a priority stored in storage unit 20C.

### 2. Control Structure

(1) First Exemplary Processing

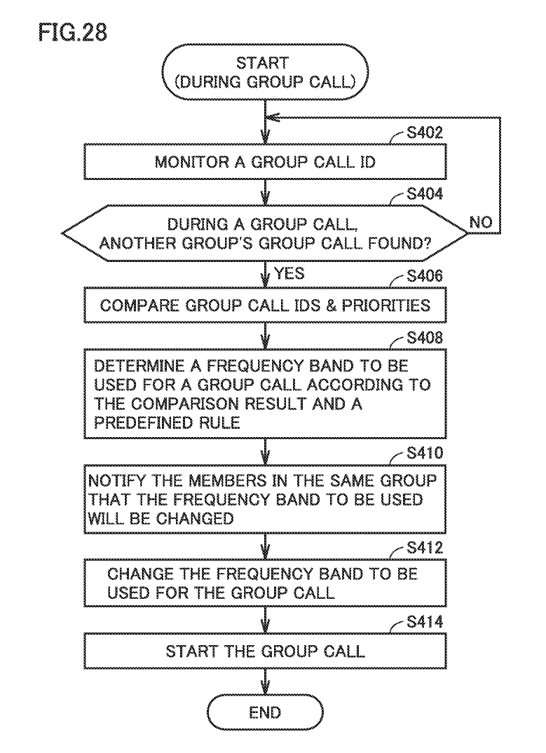

FIG. 28 is a flowchart for illustrating an example of a flow of a processing in UE 100. Referring to FIG. 28, during a group call, in step S402, UE 100 monitors a group call ID. That is, UE 100 monitors a group call ID transmitted from another UE 100. Subsequently, UE 100 performs step S404 et seq. Steps S404, S406, S408, S410, S412, S414 are identical to steps S104 and 106 described in the first embodiment (see FIG. 3). Accordingly, they will not be described repeatedly.

(2) Second Exemplary Processing

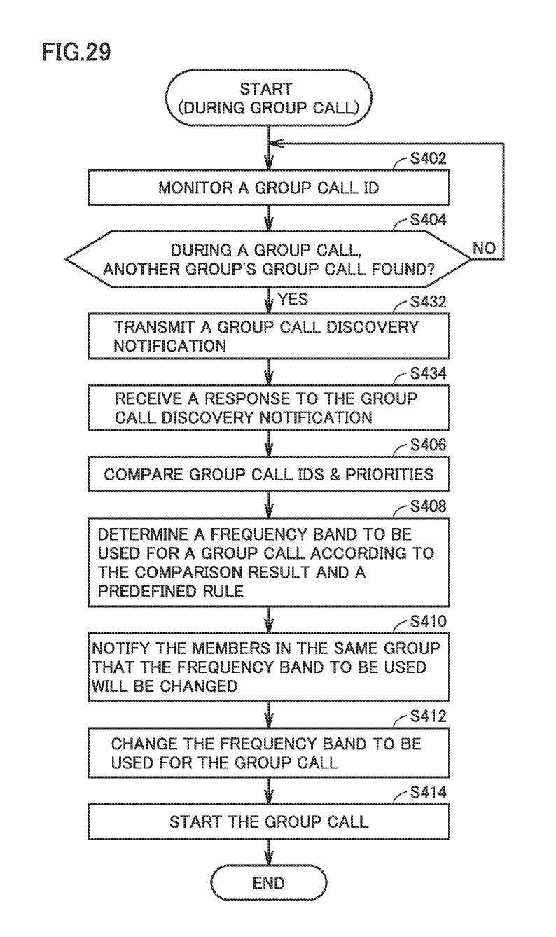

FIG. 29 is a flowchart for illustrating another example of a flow of a processing in UE 100. FIG. 29 indicates a second exemplary processing, which differs from the first exemplary processing indicated in FIG. 28 in that the former includes steps S432 and S434 between step S404 and step S406 indicated in FIG. 28. Furthermore, steps S432 and S434 are identical to steps S132 and 134 described in the first embodiment (see FIG. 4). Accordingly each step in FIG. 29 will not be described repeatedly. It should be noted that UE 100 may be configured so as to perform step S406 without performing step S434.

Furthermore, UE 100 may transmit the above-described group call discovery notification to UE 100 of its own group, or may transmit, the group call discovery notification to UE 100 of a found other group.

When UE 100 transmits a group call discovery notification to UE 100 of its own group, UE 100 includes the group call ID of the found other group in the group call discovery notification. The group call discovery notification may be transmitted by using a group call or by using a discovery signal.

When UE 100 transmits a group call discovery notification to UE 100 of the found other group, UE 100 includes the group call ID of its own group and the group call ID of the found other group in the group call discovery notification. In that case, UE 100 transmits the group call discovery notification by using the discovery signal.

(3) Sequence in the Case of the Second Exemplary Processing

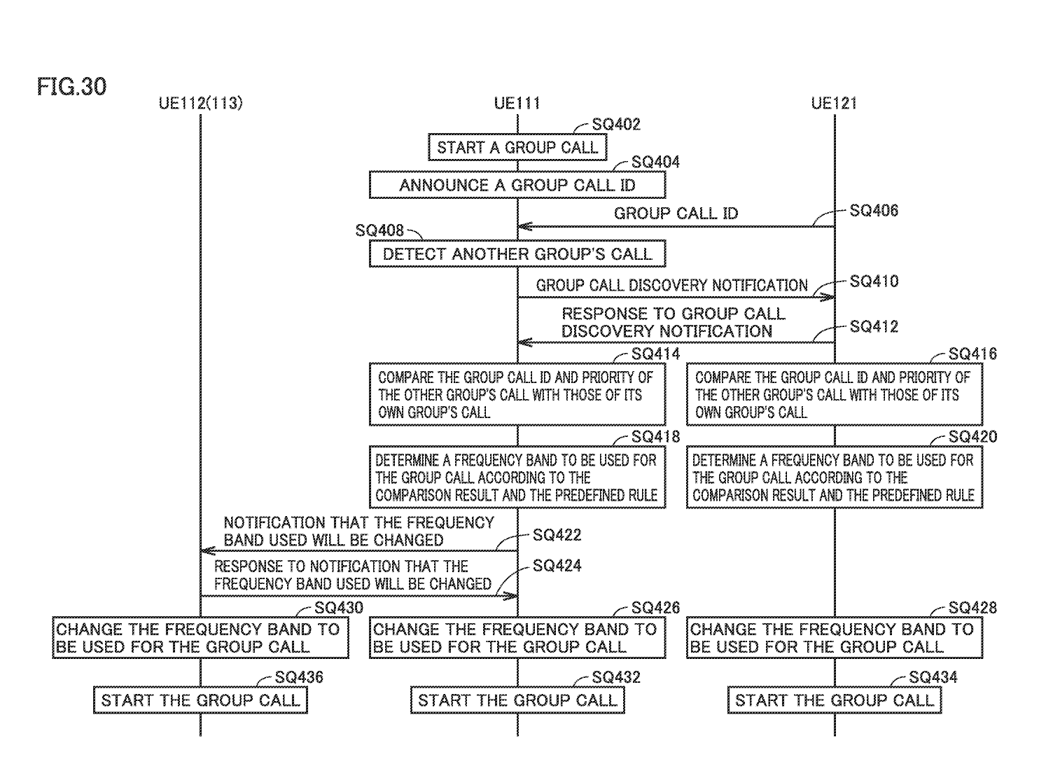

FIG. 30 is a sequence diagram for illustrating a flow of a processing in communication system 1 in an aspect. Specifically, FIG. 30 is a diagram for illustrating a sequence in a case where a processing based on the above-described second exemplary processing is performed in UE 111. Hereinafter, a configuration in which a group call discovery notification is transmitted to UE 100 of another group will be described.

Referring to FIG. 30, in a sequence SQ402, UE 111 belonging to the first group starts a group call with UEs 112 and 113 belonging to the first group. In a sequence SQ404, UE 111 announces the group call ID of the group of UE 111 (that is, the first group) to another UE 100. In a sequence SQ406, UE 121 of the second group announces the group call ID of the group of UE 121 (that is, the second group) to another UE 100.

Thereafter, sequence SQ408 et seq. are performed. Note that sequences SQ408, SQ410, SQ412, SQ414, SQ416, SQ418, SQ420, SQ422, SQ424, SQ426, SQ428, SQ430, SQ432, SQ434, SQ436 are identical to sequences SQ108, SQ110, SQ112, SQ114, SQ116, SQ118, SQ120, SQ122, SQ124, SQ126, SQ128, SQ130, SQ132, SQ134, SQ136 having been described in the first embodiment (see FIG. 5) and accordingly, will not be described repeatedly.

### 3. Advantage

Communication system 1 according to the present embodiment can prevent interference among a plurality of group calls by previously defining a method of determining a frequency to be used when a group other than an own group which is making a group call is found, as described above. Furthermore, the system allows a resource for a frequency to be utilized efficiently. In other words, the system allows radio waves to be utilized efficiently.

Specifically, UE 100 with a higher priority can use a frequency band more preferentially than UE 100 with a lower priority. Furthermore, when UE 100 set high in priority does not exist, UE 100 with the lower priority can use a wider frequency band for a group call than when UE 100 set high in priority exists.

### 4. Sub Summary

A part of a characteristic processing of the above processing is summarized for example by focusing on UE 111, as follows:

UE 111 is a device capable of making a group call by device-to-device communication without going through a base station. The group call is performed by selectively using at least one of a plurality of frequency bands. UE 111 comprises control unit 10C, a memory (storage unit 20C) having a predetermined rule (a predefined rule) stored therein, and a communication IF (communication unit 30).

When a group call is being made with UEs 112 and 113 and another group's call is also found, control unit 10C determines based on the predetermined rule a frequency band to be used for a subsequent group call with UEs 112 and 113. Control unit 10C notifies UEs 112 and 113 of the determined frequency band via the communication IF. Control unit 10C sets the frequency hand to be used for the group call with UEs 112 and 113 to the determined frequency band.

### 5. Exemplary Variation

In the above description, a configuration has been described in which UE 100 that has detected another group's call notifies UE 100 in the same group of a frequency band (or band class) to be used for a subsequent group call. Hereinafter, a configuration will be described in which UE 100 that has detected another group's call does not notify UE 100 in the same group of a frequency band to be used for a subsequent group call. Specifically, a configuration will be described in which not only UE 100 that has detected another group's call but also UE 100 in the same group as UE 100 that has detected the other group's call are compared in priority or the like and a frequency to be used for a group call is changed based on a result of the comparison.

### (1) First Exemplary Variation

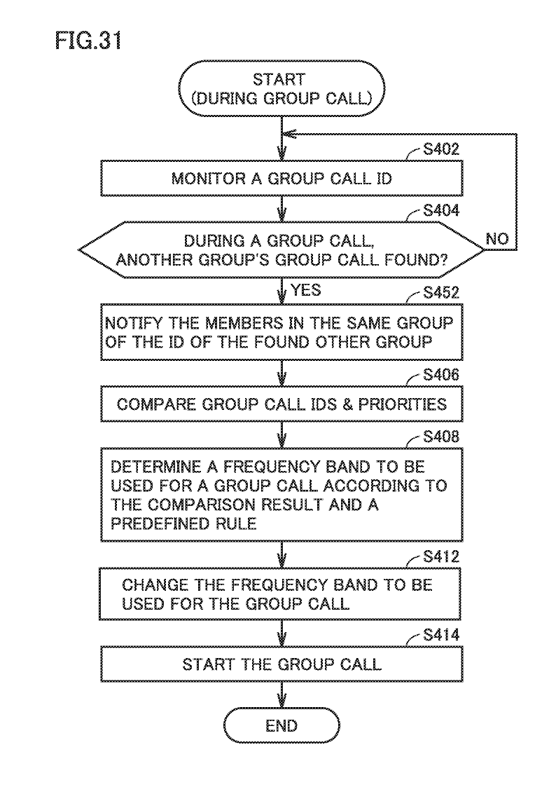

FIG. 31 is a flowchart for illustrating a flow of a processing of UE 111. FIG. 31 shows a flow of a series of processing steps, which differs from that indicated in FIG. 28 in that the former includes step S452 between step S404 and step S406 in FIG. 28 and excludes step S410.

In step S452, UE 100 notifies the members (UEs 100) in the same group as UE 100 of the group call ID of a found other group's call. For example, UE 111 of the first group notifies UEs 112, 113 of the first group of the group call ID of the found other group's call.

Each step in FIG. 31 other than step S452 has already been described, and accordingly, will not be described repeatedly.

(2) Second Exemplary Variation

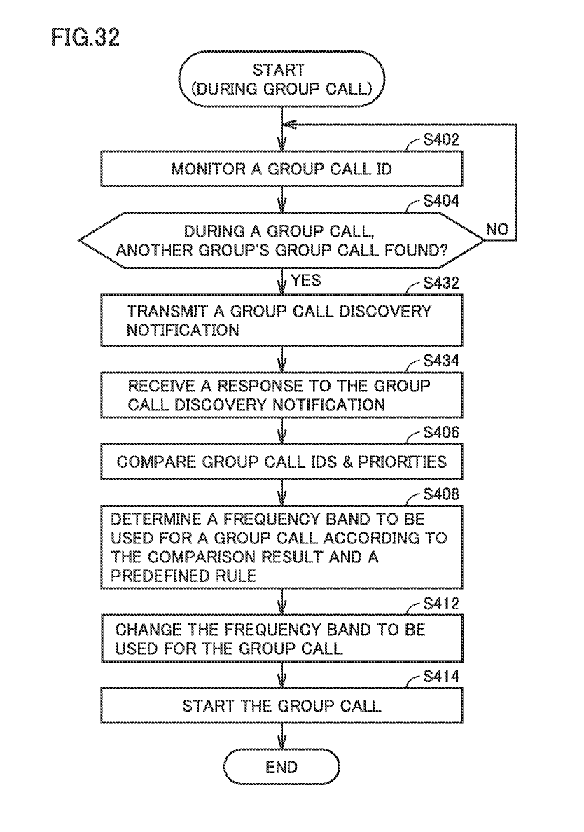

FIG. 32 is a flowchart for illustrating a flow of a processing of UE 111. FIG. 32 shows a flow of a series of processing steps, which differs from that indicated in FIG. 29 in that the former excludes step S410 shown in FIG. 29.

In step S432, UE 100 transmits the above-described group call discovery notification to at least UEs 100 of its own group. It should be noted that in step S432 UP 100 may transmit the group call discovery notification to UE 100 of a found other group. The other steps are the same as those shown in FIG. 29, and accordingly, will not be described repeatedly.

Note that when UE 100 transmits a group call discovery notification to UE 100 of its own group, UE 100 includes the group call ID of the found other group in the group call discovery notification. The group call discovery notification may be transmitted by using a group call or by using a discovery signal.

Furthermore, when UE 100 transmits a group call discovery notification to UE 100 of the found other group, UE 100 includes the group call ID of its own group and the group call ID of the found other group in the group call discovery notification. In that case, UE 100 transmits the group call discovery notification by using the discovery signal.

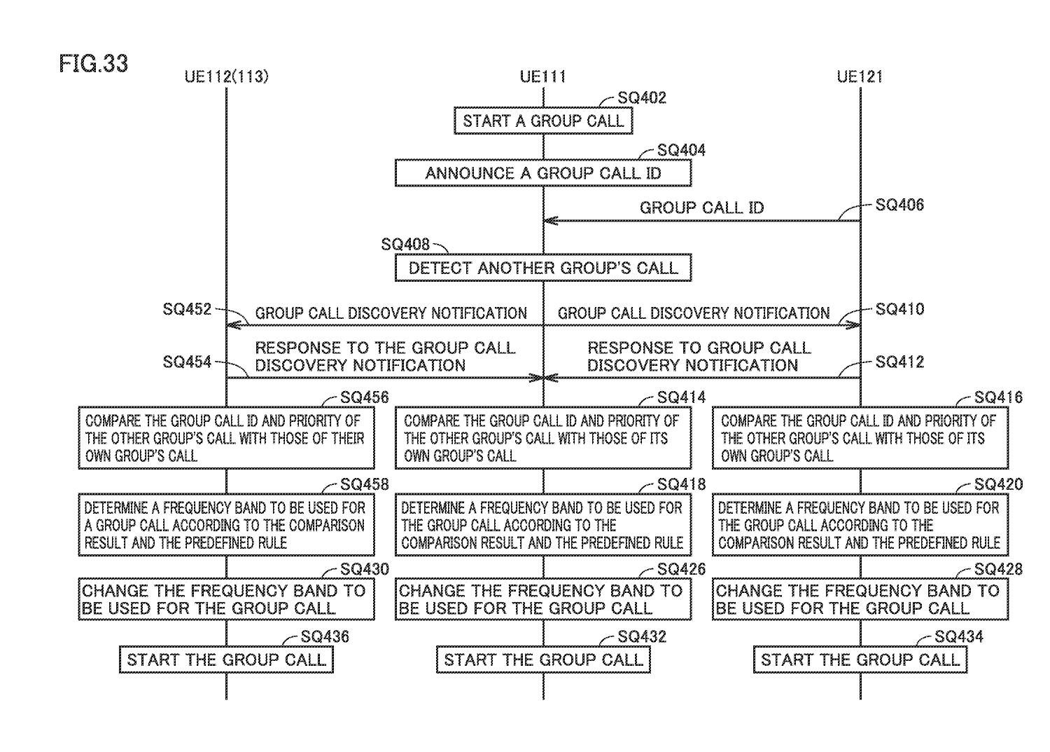

FIG. 33 is a sequence diagram for illustrating a flow of a processing in communication system 1 in an aspect. Specifically, FIG. 33 is a diagram for illustrating a sequence in a case where the processing indicated in FIG. 32 is performed in UE 111. Furthermore, in the following description, a configuration in which a group call discovery notification is also transmitted to UE 100 in another group will be described.

FIG. 33 shows a flow of a series of processing steps, which differs from that indicated in FIG. 30 in that the former further includes sequences SQ452, SQ454, SQ456, SQ458 and excludes sequences SQ422, SQ424. Accordingly, hereinafter, sequences SQ452, SQ454, SQ456, SQ458 will be described.

In sequence SQ452, UE 111 transmits a group call discovery notification to UEs 112 and 113 of the first group. In sequence SQ454, UEs 112 and 113 respond to the group call discovery notification.

In sequence SQ456, UEs 112 and 113 compare the group call ID and priority of the other group's call with the group call ID and priority of their own group's call. In sequence SQ458, UEs 112 and 113 themselves determine a frequency to be used for a group call according to the comparison result and the predefined rule.

(3) Third Exemplary Variation

In the present embodiment, as well as in the first embodiment, a configuration for determining a frequency to be used for a group call has been described as an example, however, this is not exclusive.

The configuration according to the present embodiment may be applied to a configuration for determining a time slot to be used for a group call, as has been indicated in the second embodiment. Furthermore, the configuration according to the present embodiment may be applied to a configuration for determining a resource block to be used for a group call, as has been indicated in the third embodiment.

The processing in UE 100 in each of the first to fourth embodiments described above can be implemented by software executed by each hardware and a process module. Such software may previously be stored in a memory module. The software may be stored in another storage medium and distributed as a program product. Alternatively, the software may be provided as a downloadable program product by an information service provider connected to the so-called Internet. Such software is read from the storage medium by a reading device (not shown), or alternatively, downloaded via a communication module and thereafter temporarily stored to the memory module. The software is stored by the process module to a memory in the form of an executable program. The process module executes the program.

### 4. Summary

The contents described through the above embodiments are summarized as follows:

(1) A communication device (UE 100) comprises a communication unit (communication unit 30) configured to perform communication with another communication device (a UE), detection unit 12 configured to detect another communication different from the above communication, storage units 20, 20A, 20B, 20C configured to store a predetermined communication resource selection rule (typically, the above described frequency band selection rule, time slot selection rule, and resource block selection rule), and processing unit 11 configured to control the communication. When detection unit 12 detects the other communication, processing unit 11 selects a communication resource based on the communication resource selection rule stored in storage units 20, 20A, 20B, 20C.

(2) Processing unit 11 notifies the other communication device of information of the selected communication resource via the communication unit.

(3) A processing performed by processing unit 11 to select a communication resource is a processing to select a frequency band.

(4) A processing performed by processing unit 11 to select a communication resource is a processing to select a time slot.

(5) A processing performed by processing unit 11 to select a communication resource is a processing to select a resource block.

(6) Storage units 20, 20A, 20B, 20C store a priority of the communication. Detection unit 12 detects a priority of the other communication. The communication resource selection rule is a rule applied in selecting a communication resource based on the priority of the communication and the priority of the other communication.

(7) When detection unit 12 detects the other communication, processing unit 11 transmits a predetermined notification via communication unit 30 to a communication device that performs the other communication.

(8) A method for processing communication in a communication device (UE 100) comprises the steps of: performing communication with another communication device; detecting another communication different from the communication; and when the other communication is detected, selecting a communication resource based on a predetermined communication resource selection rule.

(9) A program for controlling a communication device (UE 100) causes the communication device to perform the steps of: performing communication with another communication device; detecting another communication different from the communication; and when the other communication is detected, selecting a communication resource based on a predetermined communication resource selection rule.

### Appended Notes

(1) A communication device (UE 111) capable of making a group call by device-to-device communication without going through a base station,

the group call being performed by selectively using at least one of a plurality of radio resources (or communication resources),

the communication device comprising:

a process module (control units 10, 10A, 10B, and 10C);

a memory module having a predetermined rule stored therein (storage units 20, 20A, 20B, and 20C); and

a communication module (communication unit 30),

the process module being configured such that:

while a group call is being made with another communication device when another group's call is found the process module determines based on the predetermined rule a radio resource to be used for a subsequent group call with the other communication device;

the process module notifies the other communication device of the determined radio resource via the communication module; and

the process module sets the radio resource to be used for the group call with the other communication device to the determined radio resource.

(2) Preferably, the memory module has a priority of the group call stored therein.

The process module receives a first discovery signal via the communication module through the device-to-device communication from a communication device of another group performing the other group's call.

The first discovery signal includes the priority of the other group's call.

The process module makes the above determination based on the priority of the group call and the priority of the other group's call.

(3) Preferably, the process module transmits a second discovery signal to the communication device of the other group through the device-to-device communication via the communication module, and

the second discovery signal includes the priority of the group call.

It should be understood that the embodiments disclosed herein are illustrative and not limited to the above described contents. The scope of the present invention is defined by the terms of the claims, and is intended to include any modifications within the meaning and scope equivalent to the terms of the claims.

### REFERENCE SIGNS LIST

1: communications system; 10, 10A, 10B, 10C: control unit; 11: processing unit; 12: detection unit; 20, 20A, 20B, 20C: storage unit; 21: group call ID storage unit; 22: priority storage unit; 23: frequency band storage unit; 23A: time slot storage unit; 23B: resource block storage unit; 24: frequency band selection rule storage unit; 24A: time slot selection rule storage unit; 24B: resource block selection rule storage unit; 25: group call ID and priority storage unit; 30: communication unit; 31: transmission unit; 32: reception unit; 51: transmitting antenna; 52: receiving antenna; D6: priority table; D7: frequency table; D15: time slot table; D23: resource block table.

1. A communication device comprising:
a communication unit configured to perform communication with another communication device;
a detector configured to detect another communication different from the communication;
a storage having a predetermined communication resource selection rule stored therein; and
a processor configured to control the communication,
when the detector detects the other communication, the processor selecting a communication resource based on the communication. resource selection rule stored in the storage.

2. The communication device according to claim 1, wherein the processor notifies the other communication device of information of the selected communication resource via the communication unit.

3. The communication device according to claim 1, wherein a processing performed by the processor to select a communication resource is a processing to select a frequency band.

4. The communication device according to claim 1, wherein a processing performed by the processor to select a communication resource is a processing to select a time slot.

5. The communication device according to claim 1, wherein a processing performed by the processor to select a communication resource is a processing to select a resource block.

6. The communication device according to claim 1, wherein
the storage stores a priority of the communication,
the detector detects a priority of the other communication, and
the communication resource selection rule is a rule applied in selecting a communication resource based on the priority of the communication and the priority of the other communication.

7. The communication device according to claim 1, wherein when the detector detects the other communication, the processor transmits a predetermined notification via the communication unit to a communication device that performs the other communication.

8. A method for processing communication in a communication device, comprising the steps of:
performing communication with another communication device;
detecting another communication different from the communication; and
when the other communication is detected, select a communication resource based on a predetermined communication resource selection rule.

9. (canceled)
